(19) United States
(12) Patent Application Publication
(10) Pub. No.: US 2011/0236769 A1
(43) Pub. Date: Sep. 29, 2011

(54) THREE DIMENSIONAL ELECTRODES USEFUL FOR MICROBIAL FUEL CELLS

(76) Inventors: Xing Xie, Stanford, CA (US); Liangbing Hu, Mountain View, CA (US); Yi Cui, Stanford, CA (US); Craig S. Criddle, Redwood City, CA (US)

(21) Appl. No.: 13/070,158

(22) Filed: Mar. 23, 2011

Related U.S. Application Data
(60) Provisional application No. 61/316,641, filed on Mar. 23, 2010.

(51) Int. Cl. H01M 8/16

(52) U.S. Cl. 429/401

(57) ABSTRACT

An electrode for use in a microbial fuel cell comprising a porous substrate and nanostructure coating, for example, a carbon nanotube coating, is provided. The electrode can be configured as either a cathode or an anode, or both. Also provided is a microbial fuel cell comprising an anode compartment comprising an anode and a cathode compartment comprising a cathode and a metallic catalyst, wherein at least one of the anode and cathode comprises the porous substrate conformally coated with the nanostructure coating, and the cathode and anode are electrically connected. Methods for generating an electrical current with marine sediment or wastewater with the microbial fuel cell are also described.

### RELATED APPLICATION

This application claims the benefit under 35 U.S.C. §119(e) of U.S. Provisional Application No. 61/316,641, filed Mar. 23, 2010, which is hereby incorporated by reference in its entirety.

### BACKGROUND OF THE INVENTION

Microbial fuel cells (MFCs) convert chemical energy into electrical energy by the catalytic activity of microorganisms. Promising applications of MFCs include energy recovery from wastewater, marine sediment, and human excrement in space. The basic operation of MFCs is similar to that of other fuel cells, the oxidation of an electron donor at an anode releases electrons that pass through an external circuit to a cathode where an oxidant, such as oxygen, is reduced. In MFCs, however, oxidation at the anode is mediated by “exoelectrogens,” microorganisms that transfer electrons to an electrode. The transfer of electrons may occur by direct contact between redox-active membrane-bound proteins and the electrode surface, by the diffusion of redox-active molecules that ferry electrons between the electrode surface and the cell, or by conduction through microbially generated nanowires (or a solid matrix) that link cells to the electrode surface.

Prior studies have investigated various carbon-based electrodes in MFCs, including carbon cloth, carbon paper, carbon foam, and reticulated vitrified carbon. A graphite fiber brush anode has also been employed, as well as carbon-based anodes and composite anodes.

To date, electrode performance remains one of the most important factors limiting the power density of MFCs for practical application. The present invention addresses this and other needs.

### SUMMARY OF THE INVENTION

Embodiments of the present invention provides an electrode for a microbial fuel cell, a method for making the electrode, as well as microbial fuel cells and methods of their use for generating electricity. The electrode for the microbial fuel cell can be configured as an anode or a cathode. The electrode comprises a porous substrate and a conductive nanostructure coating. In the case of the anode, the porous substrate supports internal colonization of bacteria and high density biofilm formation. The conductive nanostructure coating supports tight mechanical contact between microorganisms and the anode.

In one aspect, an embodiment of the present invention is directed to an electrode for a microbial fuel cell. The electrode comprises a porous substrate, which has a conductive nanostructure coating. The pores may be macroporous or microporous, and may have cross-sections that vary within the range of about 10 μm to about 100 mm, or about 20 μm to about 100 mm. For example, the substrate may have a median or mean pore cross-section in the range of about 50 μm to about 10 mm.

The porous substrate may be selected from any suitable material, and need not be conductive. For example, the porous substrate may be formed or fabricated from cotton, paper, textile, rubber, wood, synthetic polymer, copper, stainless steel, nickel, ceramic, sponge (natural or synthetic) or glass. In certain embodiments, the porous substrate is ceramic (natural or synthetic), and is formed from one or more of coral, silicon dioxide (SiO₂), silicon nitride (Si₃N₄), aluminum oxide (Al2O₃), kaolinite (Al₂Si₂O₅(OH)₄), silicon carbide, tungsten carbide and zinc oxide.

The electrode has a conductive nanostructure coating and may be appropriately selected to enhance microbial contact (anode) or to provide high specific catalyst-electrolyte interfacial surface area (cathode), and may be selected from one or more of single wall carbon nanotubes, multiwalled carbon nanotubes, metal nanoparticles, transparent and conductive oxide (TCO) nanoparticles, metal nanowires, and graphene.

In another aspect, an embodiment of the invention provides a microbial fuel cell employing the electrode of the invention, either as a cathode or anode, or both. In some embodiments, the microbial fuel cell of the invention comprises both an anode and a cathode, each comprising the porous substrate conformally coated with the nanostructure material. In embodiments where the porous substrate is used for both the anode and cathode, the substrate may be the same or different. Likewise, the nanostructure coating may be the same or different.

In one embodiment, the microbial fuel cell comprises an anode compartment comprising the anode, and a cathode compartment comprising a cathode, for example, a cathode comprising the porous substrate, e.g., a macroporous substrate, coated with the nanostructure material. The anode and cathode compartments are separated by an ion exchange membrane, for example, a proton exchange membrane, and the anode and cathode are electrically connected. In a further embodiment, the cathode comprises a metallic catalyst, for example, a platinum catalyst. The catalyst can be deposited in the form of nanoparticles. As described herein, the microbial fuel cell employing the anodes and cathodes of embodiment of the invention provide improved power density and improved energy production.

In certain embodiments, the microbial fuel cell comprises a plurality of anodes, where at least one of the anodes comprises the porous substrate having the conductive nanostructure coating. In other embodiments, the microbial fuel cell comprises a plurality of cathodes, where at least one of the cathodes comprises the porous substrate having a conductive nanostructure coating. Each of the cathodes is electrically connected to at least one anode.

Also provided herein are methods for fabricating the highly conductive three dimensional electrode for use in a microbial fuel cell. In one embodiment, the method comprises coating at least one surface of a porous substrate with a nanostructure dispersion, and drying the coated substrate. For example, the coating step may comprise dip coating the substrate in the nanostructure dispersion.

Yet another aspect of the invention is a method for generating an electrical current with the microbial fuel cell. The method comprises, in one embodiment, introducing a feedstock solution comprising a carbon source and biofilm forming microorganism into the anode compartment of the microbial fuel cell. Biofilm formation is allowed to form on the surface of the anode, which then provides for an electric current as microbes within the biofilm oxidize substrate material present in the anode compartment, and transmit electrons to the cathode compartment through the electrical connection.

### BRIEF DESCRIPTION OF THE FIGURES

FIG. 1 is a schematic of the basic operation of one embodiment of a microbial fuel cell, showing the basic mechanism for current generation (left) and a schematic of one embodiment of the cathode of the invention comprising a nanostructure-textile-catalyst composite in aqueous electrolyte (right). While the electrochemical deposition method guarantees electronic access to the catalyst (e.g., platinum), the open and macroscale porous structure of the CNT-textile facilitates the contact between the catalyst and the aqueous electrolyte containing oxygen.

FIG. 2 is a schematic of the carbon nanotube-textile (CNT-textile) composite (right), the electrode configuration and electron-transfer mechanisms for the CNT-textile anode (right), compared with a schematic of a carbon cloth (CC) anode and its electron transfer mechanisms (left).

FIG. 3, left, shows a scanning electron microscope (SEM) image of the CNT-textile showing the open macroscale porous structure. The inset is a 15 cm×15 cm piece of CNT-textile with a sheet resistance of 4 Ωsquare⁻¹. Right: SEM image of a textile fiber conformally coated with CNTs.

FIG. 4 shows a cross section image of the CNT-textile fiber. The diameter of the CNT-textile fiber is about 20 μm, and the thickness of the CNT coating is about 200 nm.

FIG. 5 is an I-V curve of the conductivity measurement for a 1 mm long segment of the CNT-textile fiber. The conductance is calculated to be ˜50 S cm⁻¹.

FIG. 6. Left: Cyclic voltammograms for the CNT-textile anode before and after bacterial colonization. A positive current indicates glucose oxidation. The scan rate was 10 mV s⁻¹. Right: Graph showing the voltage generation of the MFC across a 1 kΩ external resistor. An operating voltage higher than 0.3 V indicates successful startup.

FIG. 7 is an image of a lab scale classic H-shaped two-chamber microbial fuel cell.

FIG. 8 is an SEM image of the microorganisms on the CNT layer of the anode.

FIG. 9 is a graph showing the voltage recording, over time, of the microbial fuel cell (MFC) equipped with a CNT-textile anode. The loading resistance was 1 kΩ. Day 0-27 is the startup phase of the MFC. In this period, the MFC was fed 0.15 g glucose (for 0.15 L anolyte) and inoculated with 2% domestic wastewater both on day 0 and day 5. The media was replaced with 0.2 g L⁻¹ glucose media on day 28 after the first successful operational cycle, in order to get rid of the undesired microbial growth in the media. Additional glucose (0.03 g during day 28-55 and 0.15 g after day 55) was fed when the voltage dropped below 0.02 V. The CNT-textile anode was sampled for SEM on day 32 and day 55. The anode samples for microbial community analysis and mechanical binding test were also sampled on day 55. After day 55, the remained anode size was about 1 cm×1 cm.

FIG. 10 is a graph showing the structure of the microbial community on the CNT-textile anode based on a 16S rRNA gene clone library.

FIG. 11 is an SEM image of the projective surface of a carbon cloth anode.

FIG. 12 are SEM images of the microbial growth on the CNT-textile and the carbon cloth. Left: Cross section of the CNT-textile anode illustrating internal colonization. A microbial biofilm wraps around each CNT-textile fiber, including both exterior and interior fibers. Right: Cross section of the carbon cloth anode. The biofilm is largely restricted to the outer surface of the carbon cloth anode (area between two broken lines), with few microorganisms present on the interior fibers.

FIG. 13 are images of microbial nanowires produced by microorganisms growing on the CNT-textile anode. Left: A cluster of microorganisms extending outward from the CNT-textile fiber, bound by intensive microbial nanowire networks. Right: A microorganism suspended from the anode surface, anchored by nanowire interactions with other microorganisms. The arrow indicates the microbial nanowire.

FIG. 14 are images of microbial nanowires produced by microorganisms growing on the CNT-textile anode. Left: Microbial nanowire extending from the cell membrane and penetrating the CNT layer. Right: Microbial nanowire compactly attaching to the CNT layer. The arrows indicate the microbial nanowires.

FIG. 15 is a graph showing the performance of MFCs equipped with different anodes (CNT-textile vs. carbon cloth). Repeatable power generation cycles with a 1 kΩ loading. Arrows indicate glucose feeding (0.15 g for 0.15 L of anolyte). Power outputs are normalized to the projective surface area of the anode.

FIG. 16, left: Linear staircase voltammograms showing that the maximum current density achieved by the CNT-textile anode is 2.6 times that achieved by the carbon cloth anode (7.2 vs 2.8 A m⁻²). Right: Polarization curve showing that the maximum power density of the MFC prepared with the CNT-textile anode is 68% higher than that prepared with the carbon cloth anode (1098 vs. 655 mW m²).

FIG. 17 is a Nyquist curve of the electrochemical impedance spectroscopy test for the microbial fuel cells equipped with the CNT-textile anode and the carbon cloth anode, respectively. The area within the square is magnified in an inset graph. The charge-transfer resistance between the CNT-textile anode and the electrolyte, indicated by the diameter of the first semicircle of the Nyquist curve, is 10% of the resistance between the carbon cloth anode and the electrolyte (approximately 30 vs 300Ω).

FIG. 18 are images of microbial biofilm developed on a CNT-textile anode (left) and a carbon cloth anode (right).

FIG. 19 are images of the projective surface of the CNT-textile anode (left) and the carbon cloth anode (right) after 5 min of bath sonication (100 W) and 10 seconds of vortex agitation (2700 rpm). Biofilms are still visible on the CNT-textile fibers (left) but not on the carbon cloth fibers (right), suggesting stronger mechanical binding of the microbial biofilm to the CNT-textile anode.

FIG. 20 is an SEM image of the surface of plain CNT-textile, displaying the macroscale porous structure and the conformal CNT coating (left); and an SEM image of the CNT-textile-Pt, showing the uniform distribution of Pt nanoparticles (right).

FIG. 21 are SEM images of a commercial CC-Pt cathode projective surface (top, bottom left) and cross-section of the same (bottom right).

FIG. 22 is a linear staircase voltammetry (LSV) graph showing the oxygen reaction activities of different cathodes. Current densities were normalized by the projected surface area of the cathode (2 cm²).

FIG. 23 is a graph of cyclic voltammetry measurements showing the stability of the CNT-textile-Pt cathode. Current densities were normalized by the projected surface area of the cathode (2 cm²). Fluctuations on the curve are caused by the continuous aeration of the electrolyte. Scan rate: 10 mV s⁻¹.

FIG. 24 are polarization curves of MFCs with different cathodes. Power and current densities were normalized by the projected surface area of electrodes (2 cm²).

FIG. 25 are polarization curves of MFCs equipped with CNT-textile-Pt cathodes with different Pt loadings. Power and current densities were normalized by the projected surface areas of the electrodes (2 cm²).

FIG. 26 is a transmission electron micrograph showing clusters of Pt particles deposited on the CNT-textile surface.

FIG. 27 are X-ray diffraction patterns of the CNT-textile-Pt and the CC-Pt.

FIG. 28 are cyclic voltammetry curves for the electrochemically active surface (ECAS) measurement. Electrolyte: 0.25 M H₂SO₄; Scan rate: 20 mV s⁻¹. The value of 210 μC cm⁻¹ was used for determining the ECAS area from the desorbed hydrogen.

FIG. 29 is a SEM of carbon fiber with electrochemically deposited Pt nanoparticles.

FIG. 30 are SEM images of two different sponges coated with carbon nanotubes. The top three images correspond to the first sponge and the bottom three images correspond to the second sponge. Scale bars, first sponge (left to right): 500 μm, 20 μm, 1 μm. Scale bars, second sponge (left to right): 500 μm, 100 μm, 1 μm.

### DETAILED DESCRIPTION OF THE INVENTION

Embodiments of the present invention provide three-dimensional electrodes for microbial fuel cells. The electrodes provided herein each harness a porous substrate conformally coated with a nanostructure material. When configured as an anode, this configuration design combines an open macroscale porous structure for internal microbial colonization by diverse microflora, and an affinitive anode surface for improved electron transfer. The anode is conductive, stable and biocompatible. When configured as a cathode, the open and porous substrate provides a highly specific catalyst-electrolyte interfacial surface area.

### Microbial Fuel Cell (MFC) Components

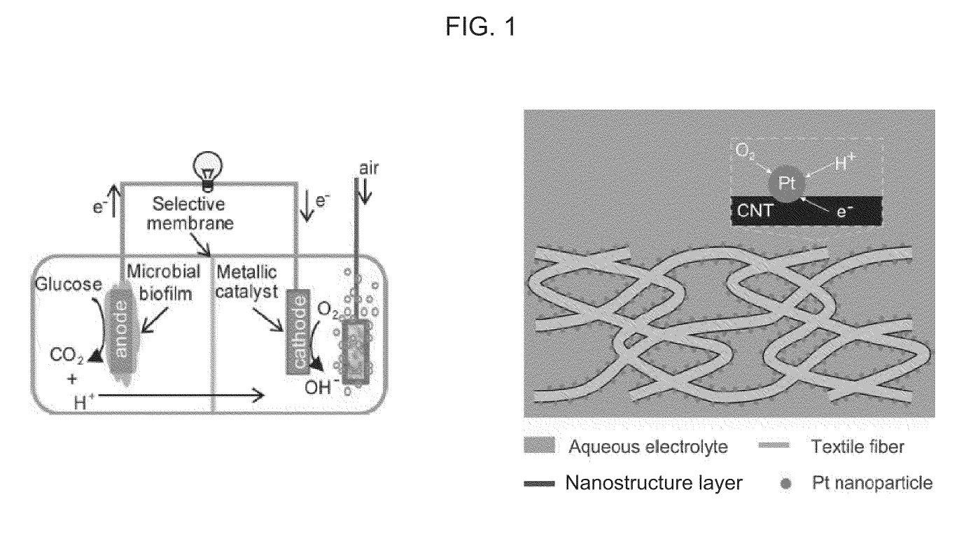

Microbial fuel cells (MFCs) can recover energy from waste, e.g., wastewater, due to the catalytic activity of microorganisms, and are promising for alleviating both energy and environmental problems. The basic operation of MFCs is similar to that of other fuel cells (FIG. 1): the oxidation of an electron donor at an anode releases electrons that pass through an external circuit to a cathode where an oxidant, such as oxygen, is reduced. In MFCs, however, oxidation at the anode is mediated by “exoelectrogens,” namely microorganisms that transfer electrons to an electrode. The transfer of electrons may occur by direct contact between redox-active membrane-bound proteins and the electrode surface, by the diffusion of redox-active molecules that ferry electrons between the electrode surface and the cell, or by conduction through microbially generated nanowires (or a solid matrix) that link cells to the electrode surface.

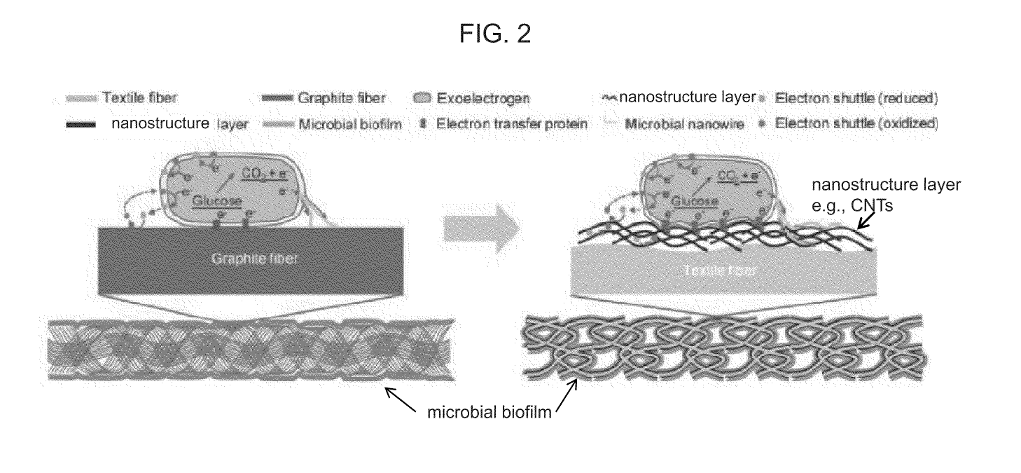

FIG. 2 provides a schematic of the electrode configuration and electron-transfer mechanisms of the nanostructure-textile anode (right), compared to a carbon cloth anode (left). In the nanostructure-textile, the intertwined macroscale textile fibers create a three-dimensional space (which in some embodiments, is on the order of 100 μm), which is designed to allow the substrate transport and colonization of microorganisms over the entire electrode surface to achieve an exceptionally high anolyte-biofilm-electrode interfacial area (anode) as well as highly specific catalyst-electrolyte interfacial surface area (cathode). In contrast, carbon cloth (CC) electrodes do not have sufficient porosity, resulting in the formation of a biofilm mostly on the outside surfaces of the electrodes. Nanostructure materials, e.g., carbon nanotubes, conformally coat the textile fibers, following their original morphology. Both the cathodes and anodes provided herein take advantage of this phenomenon.

A schematic of one cathode embodiment is also provided in FIG. 1 (right). For this nanostructure-textile-catalyst cathode, the electrochemical deposition method provides the electronic pathway to most or all of the catalyst, while the open and macroscale porous nanostructure-textile provides highly specific catalyst-electrolyte interfacial surface area. These properties make the nanostructure-textile-catalyst cathode distinct from other types of conventional cathodes. In some embodiments, the nanostructures used to coat the textile is a dispersion of carbon nanotubes, for example, single wall carbon nanotubes. Although FIG. 1 shows the cathode with a Pt catalyst, the cathodes presented herein are not limited thereto, as described further below.

The electrode provided herein comprises a macroscale porous substrate (e.g., textile) conformally coated with a nanostructure material, e.g., single wall or multi-wall carbon nanotubes, and is designed to be configured as one or more components of a microbial fuel cell. The nanostructure layer, in one embodiment, when configured as an anode, promotes active surface interaction with the microbial biofilm and facilitates electron transfer from exoelectrogens to the anode, thus resulting in high-power operation of the microbial fuel cell to which the anode is associated.

The electrode provided herein, in some embodiments, affords a two-scale porous structure—a porous nanostructure layer (e.g., carbon nanotube layer) coated onto a porous substrate, e.g., a textile. Without being bound by theory, when configured as an anode, the macroscale porous substrate provides an open three dimensional space accessible to microbial growth and the microscale nanostructure layer strongly interacts with the microbial biofilm. Similarly, the macroscale porous substrate, when configured as a cathode, provides highly specific catalyst-electrolyte interfacial surface area.

Other characteristics of the electrodes provided herein include high conductivity, chemical stability, resistance to decomposition, mechanical stability and biocompatibility. Additionally, the lightweight nature of the anodes and the ease of preparation may allow for large-scale applications.

### Electrode Structure

### Substrate

The electrodes, i.e., anodes and cathodes, provided herein employ a porous substrate for conformal coating with a nanostructure material. The large surface area of the porous substrate allows for maximal interaction with a conductive nanostructure material, e.g., carbon nanotubes (CNTs).

Rapid microbial growth can clog the pores of certain substrates used for microbial fuel cell anodes and therefore hinder the diffusion of the substrate, making the inner anode surface unfavorable for microbial colonization. Embodiments of the present invention are directed in part, to the finding that a porous substrate, e.g., a macroporous substrate, provides an open three dimensional space accessible for microbial film formation. In the context of a cathode, the substrate, when coated with a nanostructure provides a high specific catalyst-electrolyte interfacial surface area (cathode).

The pores in the electrode substrate may be of uniform shape, or may be non-uniform. Further, the aspect ratio of the pores may be uniform or non-uniform.

The size of the substrate's pores is sufficient so that the pores are not clogged (or are substantially unclogged) when a microbial film starts to form therein, and provides for high surface area. Generally, the mean or median cross-section of the pore size ranges from about 10 μm to about 500 mm, or from about 10 μm to about 400 mm, or from about 10 μm to about 300 mm, or from about 10 μm to about 200 mm, or from about 10 μm to about 100 mm, or from about 10 μm to about 10 mm, or from about 10 μm to about 1 mm.

In another embodiment, the mean or median cross-section of the substrate pores is from about 1 mm to about 300 mm, or from about 1 mm to about 200 mm, or from about 1 mm to about 100 mm, or from about 1 mm to about 10 mm. In yet other embodiments, the mean or median pore size ranges from about 10 mm to about 200 mm, or from about 10 mm to about 100 mm, or from about 10 mm to about 50 mm.

In another embodiment, the mean or median pore size is at least about at least about 15 μm, or at least about 25 μm, or at least about 50 μm, or at least about 100 μm, or at least 200 μm, or at least about 300 μm, or at least about 400 μm, or at least about 500 μm, or at least about 600 μm, or at least about 700 μm, or at least about 800 μm, or at least about 900 μm, or at least about 1 mm, or at least about 2 mm, or at least about 3 mm, or at least about 4 mm, or at least about 5 mm, or at least about 10 mm.

In another embodiment, the present invention is directed to an electrode for a microbial fuel cell having a porous substrate comprising a conductive nanostructure coating, wherein the porous substrate has a porosity ranging from about 70% to about 99%, or from about 70% to about 98%, or from about 70% to about 97%, or from about 70% to about 96%, or from about 70% to about 94%, or from about 70% to about 92%, or from about 70% to about 90%, or from about 70% to about 88%, or from about 70% to about 86%, or from about 70% to about 84%, or from about 70% to about 82%, or from about 70% to about 80%, or from about 70% to about 78%, or from about 70% to about 76%, or from about 80% to about 99%, or from about 80% to about 98%, or from about 82% to about 98%, or from about 84% to about 98%, or from about 86% to about 98%, or from about 88% to about 98%, or from about 90% to about 98%, or from about 92% to about 98%, or from about 94% to about 98%, or from about 94% to about 99%.

In one embodiment, the porous substrate is selected from one or more of cotton, paper, textile, rubber, wood, synthetic polymer, copper, stainless steel, nickel, ceramic, graphite felt, sponge (natural or synthetic) (see FIG. 30) and glass. Other substrates are for use with the invention are provided in PCT application no. PCT/US2010/54776, incorporated herein by reference in its entirety.

As stated above, the porous substrate, in one embodiment, is ceramic. In a further embodiment, the ceramic (natural or synthetic) substrate is selected from one or more of coral, silicon dioxide (SiO₂), silicon nitride (Si₃N₄), aluminum oxide (Al₂O₃), kaolinite (Al₂Si₂O₅(OH)₄), silicon carbide, tungsten carbide and zinc oxide.

The macroscale porous substrate in one embodiment, is a porous textile comprising randomly intertwined polymeric (e.g., polyester) fibers with diameters of approximately 10 μm to about 50 μm. In a further embodiment, the porous textile is conformally coated with CNTs to form a CNT-textile anode. In even a further embodiment, the CNTs are single-wall carbon nanotubes.

In one embodiment, the porous substrate comprises silicon. For example, the porous substrate can be a borosilicate fritted disk. For example, as commercially available from R&H Filter Company, Georgetown, Del. (RH1000). Borosilicate glass composition is typically about 73% silica SiO₂, 10% boron oxide B₂O₃, 8% sodium oxide Na₂O, 8% potassium oxide K₂O, and 1% calcium oxide CaO.

High surface area carbon mat nonwovens can also be used as microbial fuel cell electrode substrates. These substrates can either be electrospun or solution blown. For example, three-dimensional porous carbon fibers, produced by gas-assisted electrospinning can be employed as the electrode substrate. In another embodiment, electrospun carbon fibers are used as the electrode substrate. In even another embodiment, solution-blown carbon fibers are used as the electrode substrate. In one embodiment, electrospun carbon fibers or solution-blown carbon fibers are modified to incorporate 15% carbon black to increase porosity of the nonwovens, before use as the electrode substrate.

A substrate that is not sufficiently porous can be made so by techniques known to those of ordinary skill in the art. For example, sol-gel (Davis (2002). Nature 417, p. 813) and chemical vapor deposition (CVD) (Ying et al. (1999). Angew. Chem. Int. Edn. 38, p. 56), methods to produce silica membranes, hydrothermal synthesis to derive zeolite substrates (Nomura et al. (2005). J. Membr. Sci. 251, p. 151), anodization of aluminum (alloys) for pore patterning in alumina membranes (Masuda and Fukuda (1995). Science 268, p. 1466) and dealloying techniques to create nanoporous gold structures (Erlebacher et al. (2001). Nature 410, p. 450) can all be employed to arrive at a sufficiently porous substrate.

In addition to the above techniques, electrochemical material removal techniques can be used for fabricating porous electrode structures. For example, see Mukherji et al. (2008). Nanotechnology 19, pp. 1-8. Traditional lithographic approaches with etching can also produce nanopores; alternatively, substances can be selectively leached out of a solid, leaving pores of different shapes and sizes. In another embodiment, electrochemical phase dissolution techniques can be employed to produce meso-porous structures from simple two-phase metallic alloys.

### Nanostructure Material

The electrode of embodiments of the present invention, comprises a porous substrate as discussed, which in one embodiment, is macroporous, and coated with a nanostructure material. Various nanostructure materials can be used to coat the porous substrate. Non-limiting examples are described below. Additionally, the conductive materials provided in PCT application PCT/US2010/54776 are incorporated by reference herein.

The coatings presented herein can vary in thickness, and can be adjusted according to methods known to those of ordinary skill in the art, for example, by varying the times in coating protocols. In one embodiment, the electrode is coated with a nanostructure coating that has a thickness in the range of about 10 nm to about 500 nm, or in certain embodiments, from 50 nm to 300 nm. For example, in various embodiments the nanostructure coating is about 100 nm thick, or about 150 nm thick, or about 200 nm thick, or about 250 nm thick, or about 300 nm thick, or about 350 nm thick, or about 400 nm thick, or about 450 nm thick, or about 500 nm thick. Additionally, the coating need not be uniform, i.e., the thickness can vary from one portion of the substrate to another portion.

In one embodiment, the nanostructure material is carbon nanotubes (CNTs). When employed, CNTs can be single wall, multi-wall, or a combination thereof. The nanotubes can be fabricated by methods known to those of ordinary skill in the art, or are commercially available. For example, single-wall carbon nanotubes (SWCNTs) are available from Carbon Solutions, Inc. (Riverside, Calif.) and Unidym (Sunnyvale, Calif.). Carbon nanotubes from these companies are amenable for use with embodiments of the present invention.

Multi-wall carbon nanotubes are also available commercially, for example, from Nanocyl, Inc. (Belgium), and can be employed as the nanostructure material for the electrode of embodiments of the present invention.

In some embodiments, the CNTs have a mean or median diameter (e.g., outer diameter) in the range of about 1 nm to about 1 μm, about 1 nm to about 100 nm, about 10 nm to about 20 nm, about 10 nm to about 50 nm, about 10 nm to about 80 nm, and about 30 nm to about 70 nm, and a mean or median length in the range of about 10 nm to about 100 μm, about 100 nm to about 100 μm, about 500 nm to about 50 μm, or about 5 μm to about 50 μm.

CNTs can be dispersed in an appropriate solvent, and the dispersion can be used to coat the porous substrate. For example, the CNTs can be dispersed by sonication, in a concentrated sulfuric and nitric acid mixture for about 1 hr, about 2 hr., about 3 hr. about 4 hr. or about 5 hr., for example by the procedure outlined by Tsai et al. (Tsai et al. (2009). J. Power Sources 194, p. 199). The sulfuric acid and nitric acid, in one embodiment, is mixed in a ratio of 1:1, 2:1, 3:1, 4:1 or 5:1. The mixture can then be set still, for example, for 1 hr., before diluting with deionized water. Large particles and agglomerates can be removed from the solution by centrifuging. The centrifuged liquid can then be decanted, and filtered through a polycarbonate membrane, and washed with de-ionized water until slurry with a pH 6-7 is obtained. The slurry can then be added to a small amount of ethanol, which can then be sonicated to disperse the CNTs, resulting in a stable, dispersed product of the multi-wall carbon nanotube ink.

Carbon-nanotube ink can also be prepared by dispersing the CNTs (multi-wall or single-wall) in water with a surfactant. In one embodiment, sodium dodecylbenzene sulfonate (SDBS, Sigma-Aldrich, St. Louis, Mo.) is used as a surfactant. The amount of surfactant used, in one embodiment, is about 0.1%, or about 0.5%, or about 1.0%, or about 1.5%, or about 2%, or about 3%, or about 4%, or about 5%.

In one embodiment, the CNTs are present in the dispersion at about 0.05% by weight, or about 0.1% by weight, or about 0.15% by weight, or about 0.20% by weight, or about 0.25% by weight. In another embodiment, the CNTs range from about 0.05% to about 0.2% by weight in the dispersion.

Typically, when carbon nanotubes are dispersed in solution, sonication is employed. For example, in one embodiment, the carbon nanotube solution is dispersed with a probe-sonicator for about 10 minutes, or for about 15 minutes, or for about 20 minutes, or for about 25 minutes, or for about 30 minutes, or for about 45 minutes or for about 60 minutes at 150 W, or 160 W, or 170 W, or 180 W, or 190 W, or 200 W, or 210 W, or 220 W, to form a carbon nanotube dispersed ink. For example, the VC 505 (Sonics, Inc., Milpitas, Calif.) can be used as the sonicator-probe.

Nanotube dispersants are also available commercially, for example from Nano Lab (Waltham, Mass.), and are amenable for use with embodiments of the present invention.

In one embodiment, carbon nanotubes are used to coat a sponge substrate. For example, see FIG. 30.

In one embodiment, conductive nanoparticles are used to coat the porous substrate of the invention. For example, nanoparticle diameters can range from as few as ten nanometers to a few microns, such as with a mean or median diameter in the range of about 1 nm to about 10 μm, about 10 nm to about 1 μm, about 10 nm to about 500 nm, or about 10 nm to about 100 nm. In other embodiments, the nanoparticles can be monodisperse in size or shape. Alternatively, the nanoparticles can be polydisperse in size or shape.

In some embodiments, the nanoparticles can have any desirable shapes, such as spherical, oblong, prismatic, ellipsoidal, irregular objects, or in the form of nanorods. When in the form of a nanorod the diameter of the rods can range from a few nanometers to several tens of nanometers, or several hundreds of nanometers. In some embodiments, nanorods can have a mean or median diameter (e.g., outer diameter) in the range of about 1 nm to about 1 μm, about 1 nm to about 100 nm, about 10 nm to about 20 nm, or about 10 nm to about 50 nm, about 10 nm to about 80 nm, about 10 nm to about 90 nm, or about 30 nm to about 70 nm, and a mean or median length in the range of about 10 nm to about 100 μm, about 100 nm to about 100 μm, about 500 nm to about 50 μm, or about 5 μm to about 50 μm. Their aspect ratio can be as low as 5 to a few thousand.

In one embodiment, the nanoparticles can be gold, silver, titanium (e.g., titanium carbide particles available from Nanostructured & Amorphous Materials, Inc., Houston, Tex.), or a combination thereof. Gold nanoparticles are available commercially, for example, from Nanocs (NY, N.Y.).

Alternatively, metal nanoparticles, for example, gold or titanium nanoparticles, can be fabricated according to methods known to those of ordinary skill in the art.

Metal nanoparticles, in general, can be fabricated by both bottom-up and top-down approaches. For example, in a top-down approach, a macroscopic precursor is used as the starting material, and is divided into smaller particles by milling or through lithographic processes. Sputtering, laser ablation, vapor phase deposition and lithography all are top-down approaches, and can be employed to arrive at a nanostructure material for use as an electrode coating.

In contrast, bottom-up approaches use atomic and molecular precursors as the starting material. Self assembly and/or chemical reactions can be used to arrive at the desired nanoparticle.

In one embodiment, metal nanoparticles can be produced by liquid chemical methods by reduction of chlorauric acid or hexachlorplatinate (HAuCl₄ or H₂PtCl₆). Once the desired precursor is dissolved, a reducing agent is added, which causes metal ions to be reduced to neutral metal atoms. As this process continues, the solution becomes supersaturated, and the metal precipitates into sub-nanometer and nanometer size particles. The sub-nanometer particles can then grow by agglomeration, coalescence, ripening, etc. Growth can also be stabilized to limit the size of particles, by methods known to those skilled in the art.

Graphene is another nanostructure material that can be used as a conductive coating for the porous substrate, either for the cathode or anode, or both. As with metal nanoparticles, and carbon nanotubes, graphene is available commercially, e.g., from Angstrom Materials; Vorbeck Materials (Jessup, Md.) and XG Sciences (East Lansing, Mich.). Graphene coatings, without wishing to be bound by theory, may provide films of lower resistances because of the material's planar geometry, and highly accessible surface area. For example, see Segal (2009). Nature Nanotechnology 4, pp. 612-615.

Conductive nanowires, in one embodiment, are employed as a conductive coating for the porous substrate. For example, nanowires fabricated from gold, chromium, aluminum, titanium, niobium, platinum, silver and nickel can all be used with the anodes and methods described herein. The nanowires may be fabricated by known methods, such as lift off procedures and electron beam lithography. In certain embodiments, the nanowires are nanowire networks.

In another embodiment, silver nanowires are used as the nanostructure coating. For example, the silver nanowires can be produced in solution phase. Table 1, below, provides a recipe for silver nanowire synthesis, in accordance with one embodiment. In the first step, a mixture of 0.668 g poly-vinylpyrrolidone (PVP) and 20 mL ethylene glycol is heated in a flask at 170° C. Once the temperature is stabilized, 0.050 g of silver chloride (AgCl) is ground finely and added to the flask for initial nucleation. After three minutes, 0.22 g of silver nitrate (AgNO₃) is titrated for ten minutes. The flask is kept at the same temperature for about another thirty minutes. After the reaction is completed, the solution is cooled down, and centrifuged three times to remove solvent, PVP, and other impurities.

TABLE 1
Recipe for silver nanowire synthesis,
according to one embodiment

| | Step | Condition | | Time | | Function |
|---|---|---|---|---|---|---|
| 1 | 0.668 PVP + 20 mL | 170° | C. | 20-30 | min. | Stabilizing |
| | ethylene glycol | | | | | temperature |
| 2 | 0.050 g AgCl finely | 170° | C. | 3 | min. | Seeds |
| | ground | | | | | formation |
| 3 | 0.220 g AgNO₃ + 10 mL | 170° | C. | 10 | min. | Growing |
| | ethylene glycol | | | | | nanowires |
| 4 | Cooking | 170° | C. | 30 | min. | Completing |
| | | | | | | growth |
| 5 | Centrifuge with | 6000 | rpm | 30 | min. | Removing |
| | methanol | | | | | impurities |

In one embodiment, the nanostructure material for the electrodes provided herein comprise one or more transparent conductive oxide particles, which in one embodiment, form a film on the porous substrate. Non-limiting suitable transparent conductive oxides include indium tin oxide (ITO), ZnO, Cd₂SnO₄ and ZnSnO₃, In₂O₃:Sn, ZnO:F, Cd₂SnO₄, ZnO:AI, SnO₂:F, ZnO:Ga, ZnO:B, SnO₂:Sb, ZnO:In. See, for example, R. G. Gordon, MRS Bulletin, August 2000. Mixtures of different transparent conductive oxides may be used, in accordance with one embodiment.

In one embodiment, TCO particle diameters can range from a few tens of nanometers to few microns, such as with a mean or median diameter in the range of about 1 nm to about 10 μm, about 10 nm to about 1 μm, about 10 nm to about 500 nm, or about 10 nm to about 100 nm. In other embodiments, the TCO particles can be monodisperse in size or shape. Alternatively, the TCO particles can be polydisperse in size or shape.

In some embodiments, the TCO particles can have any desirable shapes, such as spherical, oblong, prismatic, ellipsoidal, irregular objects, or in the form of nanorods. In the form of a nanorod the diameter of the rods can range from a few nanometers to several tens of nanometers, to several hundreds of nanometers. Their aspect ratio can be as low as 5 to few thousand.

The TCO particles can be formed in the form of oxide sols by the hydrolysis of the corresponding metal-organic precursors. The mean diameter, size dispersity, and aspect ratios of the TCO particles can be controlled by various factors like concentrations, temperature and duration of the reaction.

### Methods for Making the Electrodes

In one embodiment, the microbial fuel cell electrode is fabricated by dip-coating the porous substrate into a nanostructure dispersion (for example single wall or multi wall carbon nanotubes), followed by drying of the substrate. For example, the substrate can be dried for about 2 hours at ≦100° C., or for about 90 minutes at ≦100° C. In another embodiment, the substrate is dried for about 30 minutes at 150° C. Drying time and temperature will depend on the substrate employed.

This process can be repeated multiple times, for example, two to ten times. For example, two, three, four, five, six, seven, eight, nine or ten times. Repetition may ensure the substrate, including the substrate pores, is fully coated with the nanostructure, or combination of nanostructures.

Although the examples provided below employ dip-coating of a substrate in a nanostructure dispersion, the present invention is not limited thereto. For example, physical vapor deposition, e.g., pulsed laser deposition can be employed to coat the porous substrates. Chemical vapor deposition may also be performed.

Vapor deposition of graphene can also be employed, for example in a single step chemical vapor deposition process.

Spray application coating can also be employed to coat the porous substrate, for example, by an aerosol or non-aerosol spray.

When spray coating, a nanostructure precursor or the nanostructure material itself may be sprayed onto the substrate. If the precursor is used, it is reacted on the substrate to form the nanostructure material. Typically, the number of layers, optical absorbance, and electrical conductance of the nanocoatings can be controlled by the speed of deposition, and diameter of the spray nozzle.

In another embodiment, ultrasonic atomization of nanostructure solutions is used to apply the nanostructure onto the desired substrate. In these systems, the nanostructure ink is atomized at the nozzle by pressure or ultrasound and then directed toward the substrate by a gas.

Another method for coating the porous substrate with the nanostructure material is spin coating. Single or multiple layers of nanostructure can be applied to the substrate with drying steps in between the spin coating steps.

Once the porous substrate is coated, it can be configured as either the cathode or the anode. If configured as the anode, it can be installed directly into the microbial fuel cell. If a cathode is desired, the coated substrate can then be derivatized with a metallic substrate.

If the coated nanostructure substrate is configured as a cathode, at this point, a metallic catalyst is added to the coated substrate, for example, in one embodiment, a metallic catalyst is added by electrochemical deposition. In a further embodiment, the metallic catalyst is platinum.

In one embodiment, electrochemical deposition process can be carried out in a flask, e.g., a four-neck flask, containing chloroplatinic acid (H₂PtCl₆) and hydrochloric acid (HCl) as electrolyte. For example, see, Saminathan (2009). International Journal of Hydrogen Energy 34, pp. 3838-3844. The substrate coated with the nanostructure is used as the working electrode, and two Pt meshes, one on each side of the coated substrate, can be used as counter electrodes in order to optimize the current lines and have a uniform Pt distribution on the whole current collector. The deposition, in one embodiment, is performed via a potentiostatic technique, fixing the potential at −0.6 V vs. a double junction Ag|AgCl|KCl (3.5 M) reference electrode (RE). For example, see, Saminathan (2009). International Journal of Hydrogen Energy 34, pp. 3838-3844.

Besides platinum, other metal catalysts can also be employed in the cathodes of the invention. In one embodiment, the catalyst is a late transition metal, and can be, for example, palladium (e.g., tetrachloropalladinate solution in H₂SO₄), gold, ruthenium (e.g., with a solution of Ru(NO)(NO₃)₃ in H₂SO₄), rhodium, platinum or iridium (e.g., with a solution of Na₂IrCl₆ in H₂SO₄), or a combination thereof. Regardless of the catalyst chosen, it can be deposited on the electrode to form the cathode, for example, by electrochemical deposition, as described above.

### Biocathodes

Although certain embodiments of the present invention have been described primarily with biofilms coating the anode, in some embodiments, a biofilm comprising a nitrate, chlorate or perchlorate reducing microbial community is present on the cathode of the fuel cell. In such “biocathode” embodiments, i.e., where a microbial biofilm is present on the cathode, the microbial community accepts electrons from the solid cathode. In microbial fuel cell embodiments incorporating a biocathode, a microbial biofilm may or may not be present on the anode. Additionally, a metallic catalyst may or may not be present on the biocathode. However, the cathode comprises the porous substrate and nanostructure coating, as described above. In one embodiment, biocathodes are inoculated with a chlorate-reducing enrichment from late sediment. The pH of the cathode compartment can be optimized to improved perchlorate reduction.

### Microbial Fuel Cell (MFC)

The basic structure of one embodiment of a microbial fuel cell (MFC) is provided in FIG. 1. The MFC comprises two compartments, a cathode compartment, and an anode compartment, separated by an ion exchange membrane, for example a proton exchange membrane. Both the cathode and anode are present in solution, the “catholyte” and “anolyte,” respectively. In some embodiments, one or both of the catholyte and anolyte are continuously mixed when operating the fuel cell. In one embodiment, one or both of the catholyte and anolyte are recirculated in its respective chamber when operating the microbial fuel cell. Recirculation rates will vary depending on the size and volume of the respective fuel cell compartment, and can be optimized.

In the embodiment shown in FIG. 1, the microbes in the microbial biofilm on the anode oxidize a carbon source (glucose) to yield carbon dioxide and H⁺ atoms and electrons. The electrons are passed from the microbes to the anode, which is in electrical communication with the cathode, thereby generating an electrical current. At the cathode, an oxidant (e.g., oxygen, nitrate, chlorate, perchlorate), is reduced.

According to embodiments of the present invention, the cathode or the anode, or both, comprise the porous substrate conformally coated with a nanostructure coating, as described above. In one embodiment, as detailed above, the nanostructure coating comprises carbon nanotubes, for example, single wall carbon nanotubes, multi wall carbon nanotubes, or a combination thereof.

Although the embodiment shown in FIG. 1 shows the microbes in the biofilm oxidizing a carbon source, embodiments of the present invention are not limited to such microbial fuel cells. Non-limiting sources that can be used as substrates for microbes in microbial fuel cells include, but are not limited to carbohydrates (e.g., glucose, sucrose, cellulose, starch), fatty acids (e.g., formate, acetate, butyrate), alcohols (e.g., ethanol, methanol), amino acids, proteins and inorganic compounds such as sulfides (e.g., hydrogen sulfide, acid mine drainages containing sulfide minerals. In fact, any anolyte (e.g., wastewater) comprising a source to be oxidized, for example a carbon source, can be used. In one particular embodiment, the anolyte comprises domestic wastewater. In another embodiment, marine sediment or human excrement is used as the anolyte for the microbial fuel cell. In one embodiment, the anolyte further comprises bacterial growth medium (glucose medium or otherwise), to support or stimulate the growth of microbial biofilms.

The domestic wastewater can have one or more microbes present in it, and the biofilm formed on the anode can comprise one or more of such microbes. For example, one or more of the following microbes may be present in the biofilm formed on the anode: Geobacter, Shewanella, Rhodopseudomonas, Ochrobactrum, Enterobacter, Thiobacillus thiooxidans, Thiobacillus ferrooxidans, Acidiphilium cryptum, Acidiphilium multivorum, Acidiphilium symbioticum, Acidiphilium angustum, Acidocella aminolytica, Acidocella facilis, Sulfobacillus thermosulfidooxidans, Ferroplasma acidarmanus, Metallosphaera sedula, Sulfolobus acidocaldarius, Sulfolobus solfataricus, Acidithiobacillus thiooxidans, Leptospirillum ferrooxidans, Escherichia coli, Shewanella oneidensis and Acidithiobacillus ferrooxidans. However, any bacteria that can transfer electrons is amenable for use with embodiments of the present invention. Preferably, the bacteria is already present in wastewater, sewage, marine sediment, or some other waste stream.

One advantage of embodiments of the present invention is that the anode allows for internal colonization of the substrate, and strong interaction between the microbes and the anode, including affinitive mechanical contact and higher electrical conductivity between the anode surface and microbial biofilms. Without being bound by theory, this interaction facilitates efficient extracellular electron transfer from the microbes to the anode.

Without wishing to be bound by theory, three pathways of electron transfer from exoelectrogens to the nanostructure coated anode are likely facilitated by the particular electrode structure and properties of the nanostructure layer (FIG. 1, right). First, the nanostructure coating makes the surface of nanostructure-textile fibers rough. For a single exoelectrogen with a fixed size, the rough surfaces of nanostructure-textile fibers provide more contact area than the smooth surfaces of carbon cloth fibers, as described further in the Examples, which may result in stronger mechanical binding and more efficient electron transfer between cell membranes and the anode. Second, the coated nanostructures themselves form a secondary microscale porous structure. This provides high surface area with active functional groups to collect electrons from electron mediators or shuttles in the electrolyte. In some embodiments, electron transfer by mediators or shuttles can be a predominant mechanism, and therefore, the increase in active surface area gained from the porous nanostructure layer may benefit the electron transfer. Finally, the nanostructure layer displays effective interaction with microbial nanowires (pilli). Without wishing to be bound by theory, microbial nanowires may also be conductive and provide a third route for electron transfer, and may facilitate long-range electron transfer across thicker biofilm layers.

As described above, the MFC of the invention may have one or both electrodes conformally coated with a nanostructure material, e.g., a layer of carbon nanotubes (single-wall or multi-wall, or a combination thereof). When the cathode employs such a structure, as described above, a metallic catalyst may also be present on the electrode, and is deposited by methods such as electrochemical deposition.

As described above, in one embodiment, the catalyst is applied to the cathode by an electrochemical deposition method, which provides the electronic pathway to most or all of the catalyst, while the open and macroscale porous substrate provides highly specific catalyst-electrolyte interfacial surface area (FIG. 1, right). These properties make the nanostructure-substrate-metallic catalyst cathode distinct from other types of conventional cathodes. In some embodiments, the nanostructure used to coat the porous substrate is a dispersion of carbon nanotubes or nanoparticles, as described above.

The MFC embodiment shown in FIG. 1 (left) provides O₂ as part of the catholyte. Besides O₂, the catholyte can comprise any oxidant that can be reduced. Moreover, the catholyte, in one embodiment, comprises a plurality of oxidants for reduction on the cathode. For example, CO₂, nitrate, chlorate or perchlorate can all be reduced by the cathode of the microbial fuel cell.

The electrodes provided herein can also be configured for use in other types of electrochemical cells. For example, in one embodiment, the electrode of the invention is configured as one or more components of a microbial electrolysis cell. Microbial electrolysis cells, in one embodiment, generate hydrogen gas or methane from organic material. In one microbial electrolysis cell embodiment, Pseudomonas spp. and/or Shewanella spp. are present on the anode. In one embodiment, soil or wastewater is used as the anolyte. The electrode can also be configured as one or more components of a microbial desalination cell. In one embodiment, the microbial desalination cell includes an anion exchange membrane adjacent to the anode, and a cation exchange membrane positioned next to the anode, creating a middle chamber between the anode compartment and the cathode compartment. The middle chamber is filled with water. Current is produced by bacteria as described above, and ionic species in the middle chamber are transferred to the two electrode chambers, thereby desalinating the water in the middle chamber. A plurality of anodes and/or cathodes may be present in the respective anode and cathode compartments of the microbial electrolysis cell and the microbial desalination cell. The electrodes described herein can be configured as one or more of the plurality of anodes and/or cathodes.

### MFC Architectures

As described above, the basic configuration of a MFC is provided in FIG. 1. However, other variations of this MFC architecture are contemplated. For example, in one embodiment, the anode compartment comprises a plurality of anodes, each in electrical communication with the cathode. In one particular embodiment, at least one of the plurality of anodes comprises a porous substrate, as described above, conformally coated with a nanostructure material. In a further embodiment, the nanostructure material comprises carbon nanotubes (single wall, multi wall, or a combination thereof).

In another embodiment, the plurality of anodes are in electrical communication with one or more cathodes, as described herein, i.e., a porous substrate conformally coated with a nanostructure material with a metallic catalyst (e.g., in the form of nanoparticles) deposited thereon. The nanostructure material can be any of the materials described herein, for example, carbon nanotubes. In one embodiment, the catalyst is platinum, for example, platinum nanoparticles.

Another embodiment is directed to an MFC with a plurality of cathodes in the cathode compartment. In this embodiment, each of the cathodes is in electrical communication with an anode. In one embodiment, at least one of the plurality of cathodes comprises the porous substrate conformally coated with the nanostructure material, and a metallic catalyst deposited thereon, as described above. In a further embodiment, the nanostructure material comprises carbon nanotubes (single wall, multi wall, or a combination thereof).

In another embodiment, multiple MFCs as described herein are run in series or in parallel. Additionally, the anolyte and the catholyte can be recirculated in any one particular MFC.

### EXAMPLES

Embodiments of the present invention is further illustrated by reference to the following Examples. However, it should be noted that these Examples, like the embodiments described above, are illustrative and are not to be construed as restricting the scope of the invention in any way.

Unless otherwise indicated, the materials used in the following examples were prepared according to the following methods and procedures.

### CNT-Textile Synthesis

The CNT-textile electrode was fabricated by dipping and drying of a piece of textile cloth in aqueous CNT ink (Hu et al. (2010). Stretchable, porous and conductive energy textiles. Nano Lett 120, pp. 708-714).

Aqueous CNT ink was prepared by dispersing single-wall CNTs in water with sodium dodecylbenzene sulfonate (SDBS) as a surfactant. The concentration was 0.16% for CNT and 1% for SDBS by weight. The dispersion was bath sonicated for 5 minutes followed by probe sonication for 30 minutes. A piece of textile made of randomly intertwined polyester fibers (Cloud 9 dream fleece, Wal-Mart Inc) was then dipped into CNT ink, removed and dried. The dipping-drying process was repeated for 4 times to increase the CNT loading in textile. The CNT-textile was functionalized in nitric acid (4 mol L⁻¹) before installed as the anode for MFCs.

### MFCs Construction and Operation

H-shaped two-chamber MFCs were constructed by connecting two 200 mL media bottles with a 40 mm-diameter tube. The anode was CNT-textile (1 cm×1 cm, projected area of 2 cm²) or carbon cloth (1 cm×1 cm, projected area of 2 cm², Fuel Cell Earth LLC, MA). The cathode was carbon cloth (2 cm×5 cm, projected area of 20 cm², Fuel Cell Earth LLC, MA) with a catalyst layer (0.5 mg cm⁻² 10 wt % Pt on XC-72). The anode and the cathode were connected to external circuit with titanium wire, and all exposed metal surfaces were sealed with a nonconductive epoxy (Dexter, N.J.). Anode and cathode compartments were separated by an anion exchange membrane (AMI-7001, Membranes International Inc., NJ). The distance between the anode and the cathode was about 11 cm. Domestic wastewater was used as the inoculum. The anode chamber was filled with artificial wastewater (pH ˜7), containing glucose (1.0 g L−1), NaH₂PO₄.H₂O (4.90 g L⁻¹), Na₂HPO₄ (9.15 g L−1), KCl (0.26 g L⁻¹), NH₄Cl (0.62 g L−1), mineral solution (12.5 mL L−1) and vitamin solution (5 mL L⁻¹).

During normal operation, the MFCs underwent a semi-batched feeding regime. Additional glucose (0.15 g for 150 mL anolyte) was fed intermittently when the voltage generation is lower than 0.02 V. The cathode chamber was filled with the same media, but without glucose, mineral solution, and vitamin solution. The anolyte was mixed using a magnetic stirrer (200 rpm). The cathode chamber was continuously sparged with air using a diffusion stone (0.1 L min⁻¹). The voltage across a 1 kΩ external resistor was recorded. All experiments were conducted at room temperature (˜20° C.).

### Electrochemical Characterization

The electrochemical characterization was carried out using a BioLogic VMP3 potentiostat-galvanostat multichannel equipped with electrochemical impedance spectroscopy (EIS) board. A double junction Ag|AgCl|KCl (3.5 M) reference electrode (RE) was used in the measurement. Cyclic voltammetries were performed in the potential range −0.5 V to 0.5 V vs. RE under a sweep rate of 10 mV s⁻¹. Linear staircase voltammetries were applied by increase the anode potential from −0.5 to 0 V vs. RE by 25 mV each time and recording the current after 3 minutes for equilibrium. Polarization curves were measured under a step-sweep rate of 30 mV per 5 minutes starting from the OCV value. EIS was conducted at the OCV in the frequency range of 10⁵-0.1 Hz with a 10 mV peak-to-peak sinusoidal potential perturbation. The results were reported as Nyquist plots.

### Scanning Electron Microscopy (SEM)

The pretreatment process of all the samples with microorganisms was as follows: (1) small pieces of the anode were primarily fixed overnight in the fixative containing 0.1 M sodium cacodylate buffer (Ph 7.3), 2% glutaraldehyde and 4% paraformaldehyde at 4° C., then washed with the same buffer for 5 minutes; (2) secondary fixation was performed in 1% osmium tetroxide at 4° C. for 1-2 hours, followed by washing with Milli-Q water for 10 minutes; (3) the samples were dehydrated in increasing concentrations of ethanol solution (50, 70, 90 and 100%), and critical point dried in 100% ethanol with liquid CO2; (4) the samples were finally sputter coated with 10 nm of gold. All the SEM images were taken by a field emission scanning electron microscope (FEI XL30 Sirion SEM).

### DNA Extraction, PCR, Cloning, and Sequencing

After 50 days of operation, genomic DNA was extracted from a carbon nanotube-textile (CNT-textile) anode sample (0.1 cm²) in duplicate using the FastDNA Spin Kit for soil (MP Biomedicals, Solon, Ohio) according to the manufacturer's protocol, except for the initial bead-beating step. A Vortex Adapter (MO BIO laboratories, Inc., Carlsbad, Calif.) with the Vortex Genie 2T (Scientific Industries, Inc., Bohemia, N.Y.) was used to physically disrupt cells in lysing matrix at maximum speed for 15 minutes.

Bacterial 16S rRNA genes were PCR amplified from the genomic DNA using the bacteria-specific forward primer 8F (5′-AGA GTT TGA TCM TGG CTC AG-3′) and the universal reverse primer 1492R (5′-TAC GGY TAC CTT GTT ACG ACT T-3′) (Lane (1991). 16S rRNA sequencing. In Nucleic Acid Techniques in Bacterial Systematics, eds Stackebrandt E, Goodfellow M (John Wiley & Sons, New York) pp. 115-175).

Each 25 μL PCR mixture comprised 0.25 μM of each primer, 1× Fail-Safe PCR buffer F (Epicentre, Madison, Wis.), 1.25 units of AmpliTaq LD Taq polymerase (Applied Biosystems, Inc., Foster City, Calif.), and 100-140 ng of genomic template DNA. The PCR temperature profile was as follows: an initial melting step at 94° C. for 5 minutes, followed by 35 cycles consisting of 94° C. for 45 seconds, 55° C. for 30 seconds, and 72° C. for 90 seconds, with a final extension at 72° C. for 10 minutes. Presence or absence of the expected amplicon was checked via agarose gel electrophoresis.

For 16S rRNA gene cloning and sequencing, quadruplicate PCR products were pooled and purified via gel electrophoresis using the QIAquick gel extraction kit (Qiagen Inc., Valencia, Calif.). Purified PCR products were cloned using the pGEM-T Easy Vector System and transformed into E. coli JM109 competent cells (Promega, Madison, Wis.), as per the manufacturer's protocol. To confirm the presence of ˜1500-bp 16S rRNA gene inserts, Escherichia coli transformants were grown overnight at 37° C. and used as PCR templates with T7 and SP6 sequencing primers. Forty eight clones were randomly selected and sequenced from both the T7 and SP6 priming sites on ABI 3730x1 automated sequencers by Elim Biopharmaceuticals, Inc. (Hayward, Calif.), generating a total of 48 bacterial 16S rRNA gene sequences.

### Phylogenetic Analysis

Bacterial 16S rRNA gene sequences (˜1500 bp) were compared to all available sequences in Genbank using the NCBI BLAST utility (ncbi.nlm.nih.gov/blast/Blast.cgi). Sequences were subsequently aligned with the GreenGenes NAST utility and imported in the ARB software package to a database of 236,469 16S rRNA sequences included in the Nov. 18, 2008 release of GreenGenes (greengenes.lbl.gov) (DeSantis et al. (2006). NAST: a multiple sequence alignment server for comparative analysis of 16S rRNA genes. Nucleic Acids Res 34, pp. W394-W399; DeSantis et al. (2006). Greengenes, a chimera-checked 16S rRNA gene database and workbench compatible with ARB. Appl Environ Microbiol 72, pp. 5069-5072; Ludwig et al. (2004). ARB: a software environment for sequence data. Nucleic Acids Res 32, pp. 1363-1371).

A neighbor-joining phylogenetic tree with the Jukes-Cantor correction was generated in ARB based on a multiple alignment of cloned 16S rRNA gene sequences and closely related database samples.

### Example 1

### Properties and Operation of the MFC Anode

A CNT-textile anode was prepared as described above.

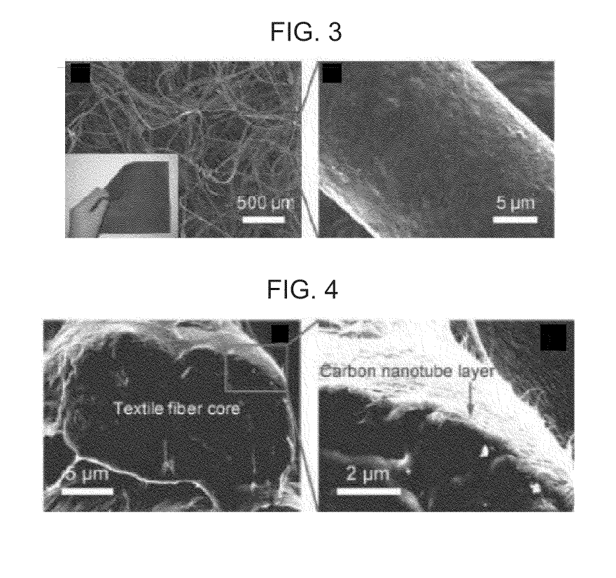

In the CNT-textile, the intertwined macroscale textile fibers (FIGS. 3, 4) created a three-dimension space (on the order of 100 μm), which is designed to allow the substrate transport and colonization of microorganisms (FIG. 2, right) deep inside the entire electrode to achieve an exceptionally high anolyte-biofilm-anode interfacial area. In contrast, carbon cloth anodes do not have suitable macroscale pores, which resulted in the formation of a biofilm only on the outside surfaces of the electrodes (FIG. 2, left). CNTs conformally coated the textile fibers, and followed their original morphology (FIGS. 3, 4).

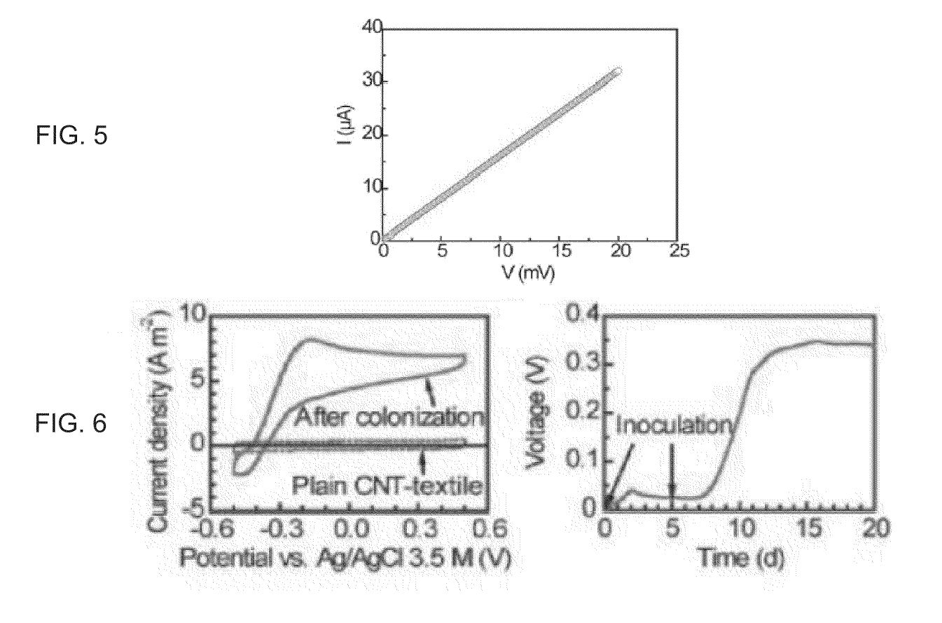

The anode comprised a ˜200-nm-thick CNT coating (FIG. 4), and the CNT-textile achieved excellent conductance (50 S cm⁻¹, FIG. 5) even when calculated using the whole cross-sectional area of the CNT-textile fiber. In contrast, the conductivity of CNT films only was 1250 S cm⁻¹.

### Operation

In order to determine whether the CNT-textile satisfied the desired three-dimensional anode configuration and improved the extracellular electron-transfer efficiency, the CNT-textile was installed as the anode in a classic H-shaped two-chambered MFC.

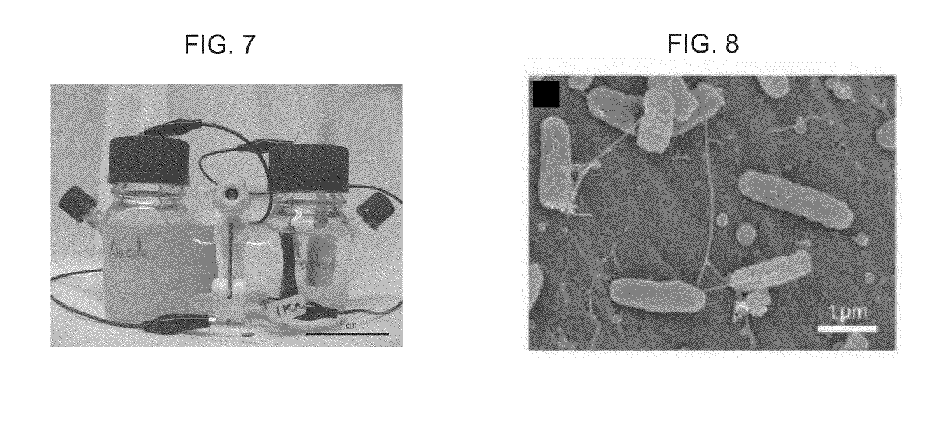

The MFC was inoculated with domestic wastewater and fed glucose. The uncolonized CNT-textile was initially inactive (FIG. 6, left). After 12 days of operation, the operating voltage increased to greater than 0.3 V across a 1 kΩ resistor (FIG. 6, right), which indicated a successful startup. During this period, the anode was colonized, and the anode compartment became turbid (FIG. 7).

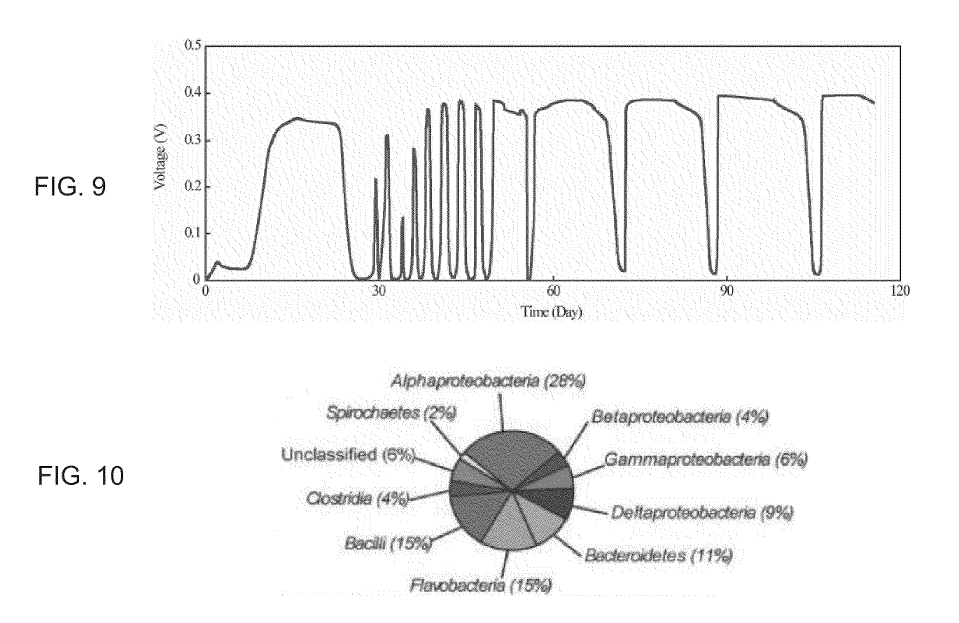

The cyclic voltammogram (FIG. 6, left) demonstrated a significant positive current peak for glucose oxidation, which is evidence of exoelectrogenic activity. A scanning electron microscope (SEM) image (FIG. 8) provided evidence of the colonization and biocompatibility of the CNT textile anode. Stable operation of this MFC was achieved for more than 4 months (FIG. 9).

For the CNT-textile anode, although the textile fiber provided mechanical support, the sole electroactive material present was CNT. Therefore, the results confirmed that CNT is biocompatible in MFCs and can function as an anode.

### Example 2

### Biofilm Analysis

The microbial community structure of the biofilm associated with the CNT-textile anode was analyzed via a bacterial 16S rRNA gene clone library. The results revealed a diverse community (FIG. 10), including taxa previously reported in MFCs and related to Geobacter, Rhodopseudomonas, Ochrobactrum, and Enterobacter (FIG. 10).

### Example 3

### Comparison of CNT-Textile Anode and a Carbon Cloth Anode

To evaluate the performance of the CNT-textile anode, an MFC with an identical configuration but with a commercial carbon cloth anode was operated in parallel with a CNT-textile-equipped MFC. A schematic of each electrode is provided in FIG. 2, along with the electron transfer mechanisms of each.

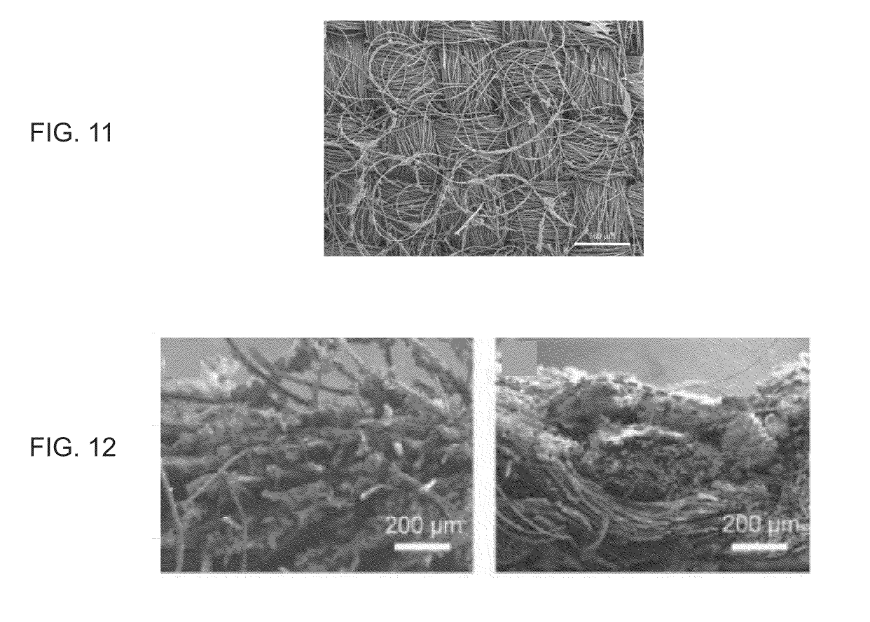

The carbon cloth is made of regularly woven graphite fibers (FIG. 11). On the basis of the physical parameters provided by the supplier (Fuel Cell Earth LLC, MA) or obtained from direct measurements, the porosities of the CNT-textile anode and the carbon cloth anode were calculated to be 95.8% and 64.6%, respectively. A greater porosity of the CNT-textile provides more space for substrate transport and colonization.

After 55 days of operation, both anodes were sampled and the cross sections were characterized under SEM (FIG. 12). For the CNT-textile anode, a microbial biofilm was wrapped around each CNT-textile fiber, including both exterior and interior fibers (FIG. 12, left), indicating that the open macroscale porous structure of the CNT-textile provided sufficient substrate transport inside the CNT-textile anode to maintain internal colonization, consistent with the schematic demonstration in FIG. 2, right.

Assuming that all of the CNT-textile fiber surfaces are occupied by biofilms, the anolyte-biofilm-anode interfacial area was calculated to be 10-fold larger than the projective surface of the anode.

In the case of the carbon cloth anode, however, microbial colonization was largely restricted to the outer surface of the anode, with few microorganisms present on the interior fibers, as evidenced in FIG. 12 (right). Few microorganisms were observed on the inner surface of the porous carbon cloth anode, suggesting poor substrate transport inside the anode. Compared with the carbon cloth, the CNT-textile is a true three-dimensional anode with a much higher active surface area for biofilm growth, which may result in improved MFC performance.

Besides the increase in the anolyte-biofilm-anode interfacial area, the CNT-textile fiber surface revealed excellent interaction with the microbial biofilm. First, the CNT coating made the surface of CNT-textile fibers rough (FIG. 3, 4). For a single exoelectrogen with a fixed size, the rough surfaces of CNT-textile fibers provided more contact area than the smooth surfaces of carbon cloth fibers (FIG. 2, left), which may resulting in stronger mechanical binding and more efficient electron transfer between cell membranes and the anode.

Second, the coated CNTs themselves formed a secondary microscale porous structure. This provided high surface area with active functional groups to collect electrons from electron mediators or shuttles in the electrolyte.

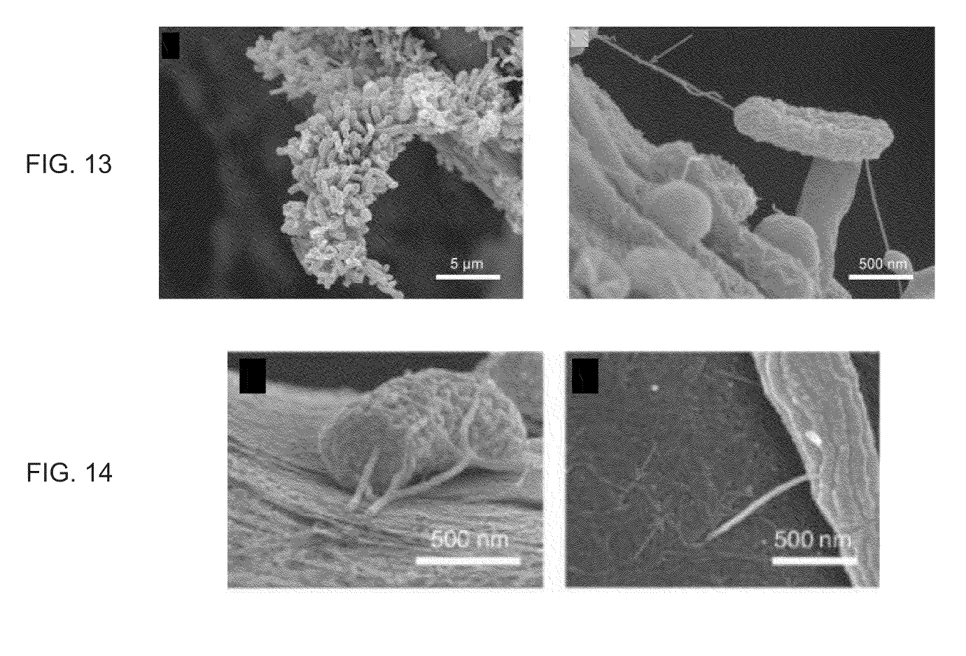

Finally, the CNT layer displayed effective interaction with microbial nanowires. A great number of microbial nanowires were observed under SEM (FIG. 13). These nanowires (pili) tethered cells to the anode surface, and facilitated the maintenance of a stable biofilm.

FIG. 14 (left) shows a bacterial nanowire bridging the gap between CNTs and penetrating the anode surface, and FIG. 14 (right) shows a bacterial nanowire compactly attached to the CNT layer. These interactions likely enhanced the bacterial nanowires' functions as tethers and electron conductors, further improving the mechanical binding and electrical conductivity between exoelectrogens and anode materials. This would not be expected for the solid surface of carbon cloth fibers (FIG. 2, left).

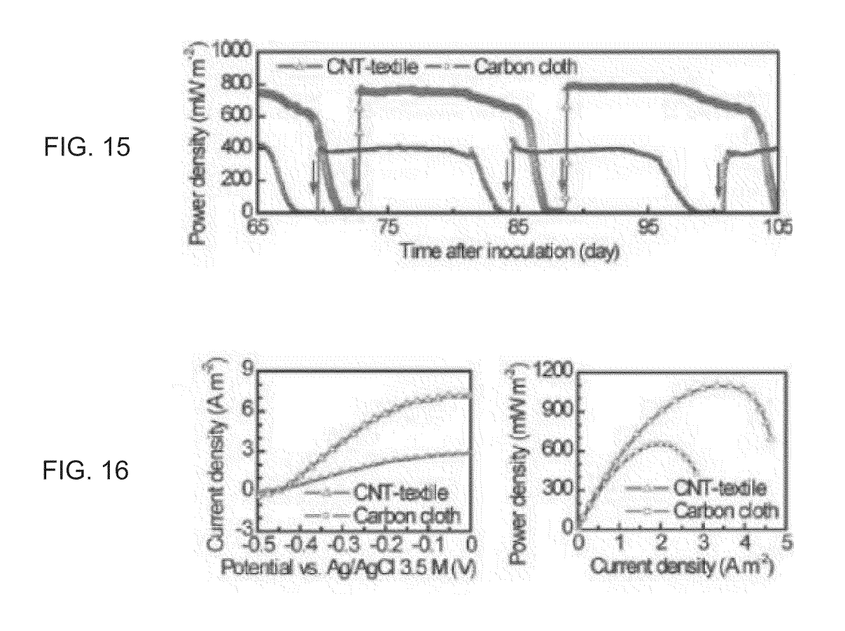

The MFC equipped with a CNT-textile anode achieved better performance than that prepared with a carbon cloth anode. Anode comparisons were made after 2 months of operation when both of the MFCs achieved repeatable power generation cycles with a 1 kΩ external resistor (FIG. 15). The open circuit potential of both anodes was about −0.45 V versus Ag|AgCl.

With the 1 kΩ loading, the potential of the CNT-textile and the carbon cloth dropped to −0.34 and −0.25 V versus Ag|AgCl, respectively. The CNT-textile showed a 0.09 V less anodic potential loss than the carbon cloth (0.11 vs 0.20 V). Maximum current density and power density measurements were applied 30 h after the replacement of fresh glucose media, when the power generation returned to steady state and the glucose concentration was still close to the original level (1 g L⁻¹).

Both the current density and power density results were normalized to the projective surface area of the anode. As shown in FIG. 16 (left), the maximum current density achieved by the CNT-textile anode was 7.2 A M⁻², which is 2.6 times that achieved by the carbon cloth anode under identical conditions (2.8 A M⁻²). With the same cathode, the maximum power density of the MFC prepared with the CNT-textile anode was 68% higher than that obtained with the carbon cloth anode (1098 mW m⁻² vs. 655 mW m⁻²), as determined by the polarization curve (FIG. 16, right).

The total electric energy generation of the MFCs was calculated by integrating the power-time curve (FIG. 15). The results show that the MFC equipped with a CNT-textile anode produced 141% more energy from the same mass of added glucose, as compared to the conventional carbon cloth anode. These data suggest that a CNT-textile anode enabled superior performance.

Electrochemical impedance spectroscopy (EIS) tests were carried out to investigate the internal resistance of both MFCs. The charge-transfer resistance was also calculated for both anodes. This parameter is indicated by the diameter of the first semicycle in the Nyquist curve.

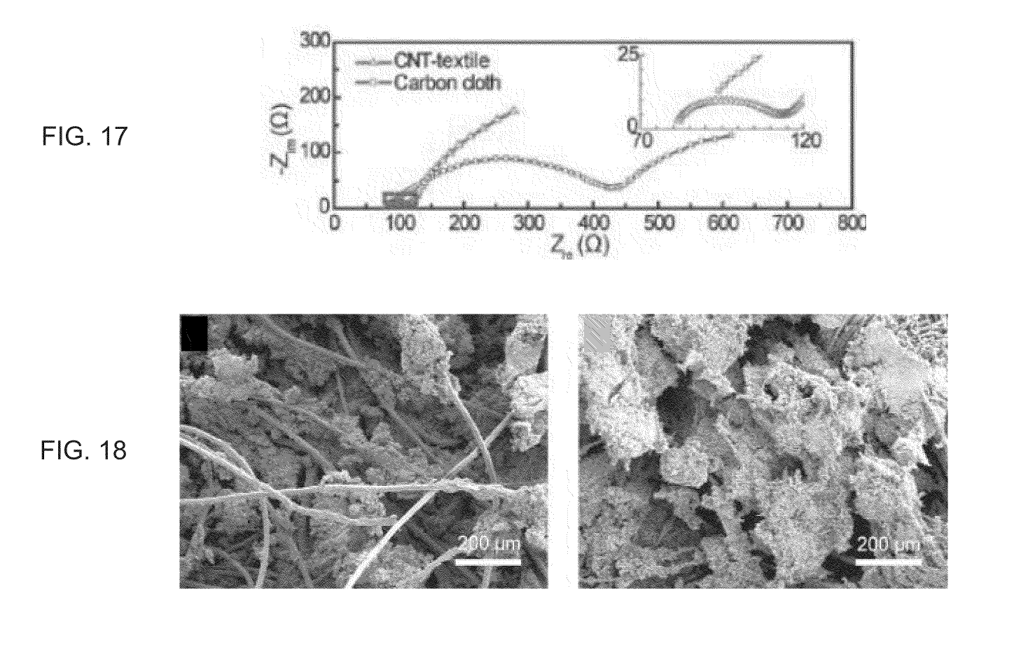

As shown in FIG. 17, the charge-transfer resistance of the MFC with the CNT-textile was about 30Ω whereas that of the MFC with the carbon cloth anode was about 300Ω. This 10-fold improvement in charge-transfer resistance suggests that the superior performance of the CNT-textile relative to that of conventional carbon cloth anodes was due, at least in part, to the higher electron transfer efficiency of the electrode material of the CNT-textile anode. Without wishing to be bound by theory, the higher electron transfer efficiency likely results from both the increased anolyte-biofilm-anode interfacial surface area and the improved interaction between the anode surface and the microbial biofilm.

In conclusion, compared with a widely used commercial carbon cloth anode, the CNT-textile achieved significantly improved MFC performance.

### Example 4

### Binding Strength of Microbial Biofilms to the CNT-Textile Anode

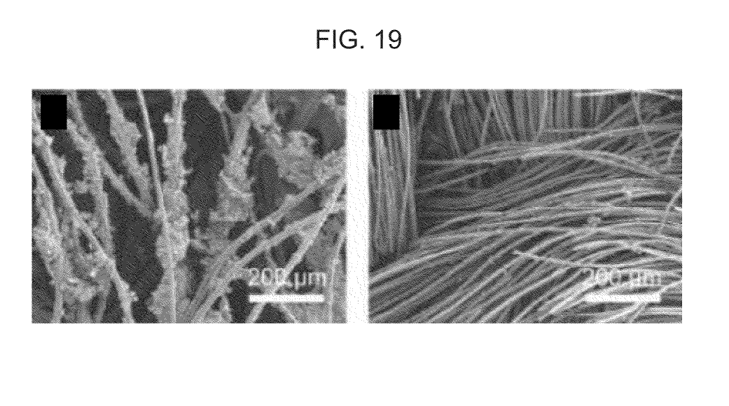

The strength of the mechanical binding of microbial biofilms to the CNT-textile anode was assessed. Anode samples with associated mature microbial biofilms (FIG. 18) were sonicated in phosphate buffer solution for 5 minutes and then subjected to vortex agitation for 10 seconds. Biofilms remained visible on the CNT-textile fibers (FIG. 19, left) but not on the carbon cloth (FIG. 19, right), suggesting stronger mechanical binding of biofilms to the CNT-textile anode than to the carbon cloth anode.

### Example 5

### Fabrication and Characterization of a CNT-Textile-Pt Cathode

### Methods

### Cathode Fabrication

A CNT-textile sheet with thickness of ˜1 mm was cut into a 1 cm×3 cm piece, and then treated with nitric acid (4 M, 2 hours) and glacial acetic acid (2 hours) successively before the Pt deposition. The acid treatment process increased the sample's hydrophilicity and produced oxygen-rich functional groups on the originally inert CNT surface to act as nucleating sites for Pt deposition.

The electrochemical deposition process was performed in a four-neck flask containing chloroplatinic acid (H₂PtCl₆, 0.019 M) and hydrochloric acid (HCl, 0.6 M) as electrolyte (Saminathan (2009). International Journal of Hydrogen Energy 34, pp. 3838-3844). The CNT-textile was the working electrode with only 1 cm×1 cm dipped into the electrolyte. Two Pt meshes, one on each side of the CNT-textile, were used as counter electrodes in order to optimize the current lines and have a uniform Pt distribution on the whole current collector. The deposition was performed via a potentiostatic technique, fixing the potential at −0.6 V vs. a double junction Ag|AgCl|KCl (3.5M) reference electrode (RE) (Saminathan (2009). International Journal of Hydrogen Energy 34, pp. 3838-3844).

### Cathode Characterization

The morphologies of the electrode surfaces were investigated using a field emission scanning electron microscope (SEM, FEI XL30 Sirion). The Pt nanoparticles were also examined by a transmission electron microscopy (TEM, FEI Tecnai G2 F20 X-TWIN 200 kV). Pt loadings were measured by an IRIS advantage inductively coupled plasma atomic emission spectroscopy (ICP-AES) system.

The average sizes of Pt particles on different electrodes were calculated by the Debye Scherrer equation, based on the X-ray Diffraction (XRD) test results.

ECAS area was characterized using an electrochemical method, in which the ECAS area was proportional to the hydrogen adsorption-desorption capability of the electrode.

Oxygen reduction efficiencies were tested by performing linear staircase voltammetries (LSVs) at step-sweep rates of 10 mV per 10 seconds from 0.3 to −0.3 V vs. a double junction Ag|AgCl|KCl (3.5M) reference electrode and cyclic voltammetries (CVs) at scan rates of 10 mV s⁻¹ between −0.5 to 0.5 V vs. a double junction Ag|AgCl|KCl (3.5M) reference electrode. The counter electrode was Pt foil, and the electrolyte was a phosphate buffer solution simulating the working condition in aqueous-cathode MFCs. The electrolyte was saturated with oxygen under ambient pressure and temperature.

### MFC Construction and Characterization

All cathode samples were investigated in an H-shaped two-chamber MFC with a CNT-textile anode (1 cm×1 cm). The MFC was inoculated with domestic wastewater and was operated for 6 months to obtain a mature biofilm on the anode. An anion exchange membrane (AMI-7001, Membranes International Inc., NJ) was used as the separator. The catholyte was a phosphate buffer solution (100 mM, pH 7) comprised of NaH₂PO₄.H₂O (4.90 g L⁻¹), Na₂HPO₄ (9.15 g L⁻¹), KCl (0.26 g L⁻¹), and NH₄Cl (0.62 g L⁻¹). The anolyte contained glucose (1 g L⁻¹), mineral solution (12.5 mL L⁻¹), vitamin solution (5 mL L⁻¹), and the same PBS as that used for the catholyte (Oh et al. (2004).

The cathode chamber was continuously purged with air using a diffusion stone (flow rate ˜0.1 L min⁻¹). To evaluate the MFC performance, polarization curves were measured under a step-sweep rate of 10 mV per 10 seconds starting from the OCV value. The anode was the working electrode and the cathode was both counter electrode and reference electrode. Power and current densities were normalized by the projected surface area of the cathode (2 cm²). All experiments were conducted at room temperature.

### Results

### SEM Images

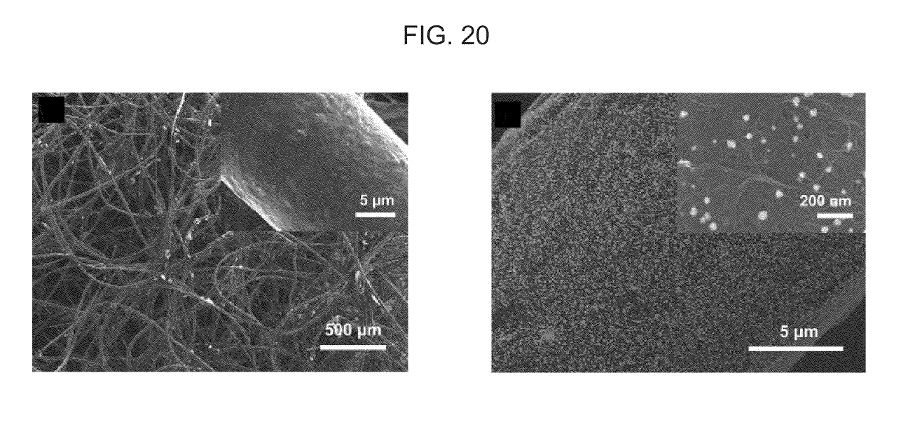

The scanning electron microscopy (SEM) image of the plain surface of CNT-textile is shown in FIG. 20 (left). The randomly intertwined textile fibers formed an open macroscale porous structure. The conformally coated CNTs made the CNT-textile highly conductive, with a sheet resistance of 4 Ωsq⁻¹. An acid treatment process (glacial acetic acid, 2 hours) increased the hydrophilicity of the CNT-textile and created oxygen-rich functional groups on the originally inert CNT surface, and acted as nucleating sites for Pt deposition. Then the electrochemical deposition process was performed in a flask containing chloroplatinic acid (H₂PtCl₆, 0.019 M) and hydrochloric acid (HCl, 0.6 M) as electrolyte, by fixing the potential of CNT-textile at −0.6 V vs. a double junction Ag|AgCl|KCl (3.5 M) reference electrode (RE) and limiting the charge at 600 mC.

FIG. 20 (right) shows the SEM image of the CNT-textile-Pt composite. Because Pt particles were deposited by electrochemical reduction, only the sites with electronic access were covered with Pt particles, with remaining sites substantially uncovered. Therefore, the electron pathways to most, or all, of the catalysts were guaranteed. As shown in FIG. 20 (right), the deposited Pt particles were uniformly distributed along the CNT-textile backbone making the Pt particles accessible by the electrolyte containing oxygen and proton. Thus, in CNT-textile-Pt, almost every Pt particle had the triple-access for oxygen reduction.

### Performance

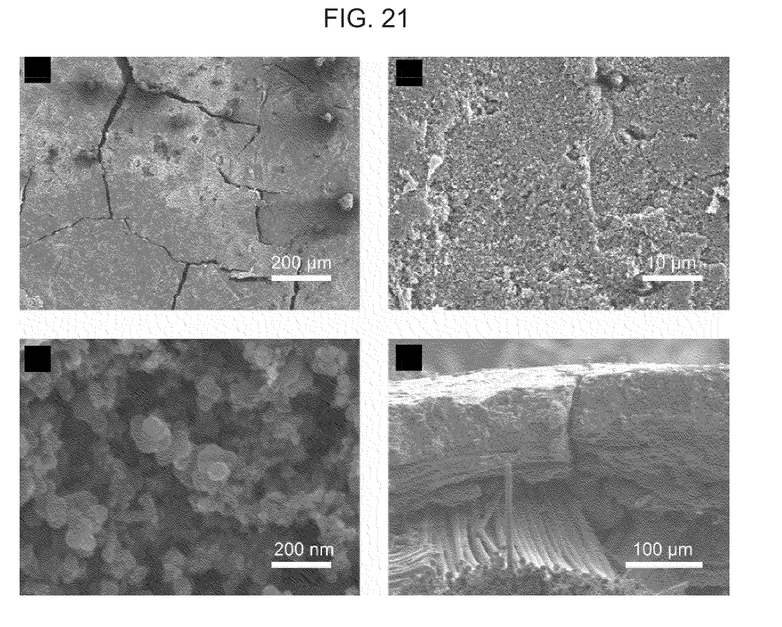

The performance of the CNT-textile-Pt composite as an aqueous cathode was compared with a commercial carbon cloth cathode with Pt catalyst (CC-Pt), which was prepared by a general painting method. Images of the commercial cathode are provided in FIG. 21.

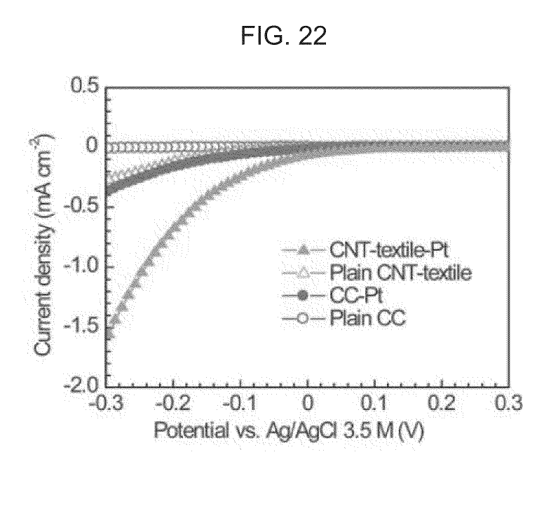

The oxygen reduction activity of the cathode samples (1 cm×1 cm) was characterized by applying linear staircase voltammetry (LSV) at a step-sweep rate of 10 mV per 10 seconds from 0.3 to −0.3 V vs. a double junction Ag|AgCl|KCl (3.5 M) RE. The electrolyte was a phosphate buffer solution saturated with oxygen under ambient pressure and temperature, in order to simulate the working condition in aqueous-cathode MFCs. As shown in FIG. 22, the CNT-textile-Pt cathode generated larger reduction currents than those of the CC-Pt.

While oxygen reduction by the plain CC without Pt was almost negligible, the plain CNT-textile without Pt also reveals certain oxygen reduction activity. However, the catalytic activity of CNTs alone is lower than that of Pt.

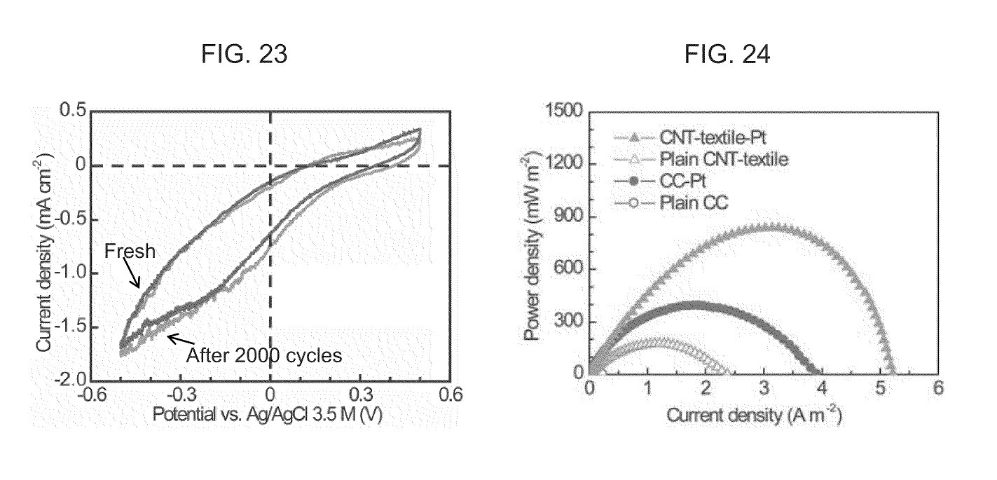

The long term stability of the CNT-textile-Pt cathode was investigated by performing cyclic voltammetry (CV) measurements at a scan rate of 10 mV s⁻¹ between −0.5 and 0.5 V vs. a double junction Ag|AgCl|KCl (3.5M) RE in the same electrolyte as that applied in the LSV tests. The result showed that the oxygen reduction activity of the CNT-textile-Pt did not decay after 2000 cycles (FIG. 23).

### MFC

Cathode samples were investigated in an H-shaped two-chamber MFC with a CNT-textile anode (1 cm×1 cm).

The MFC was inoculated with domestic wastewater and had been operated for 6 months to obtain mature biofilms on the anode. Maximum power densities of the MFCs equipped with different cathodes were determined from the polarization curves measured under a step-sweep rate of 10 mV per 10 seconds starting from the OCV value.

As shown in FIG. 24, in accordance with the results of oxygen reduction, the CNT-textile-Pt cathode showed better performance than the carbon cloth-Pt cathode with the same projection area of electrode.

The maximum power density of the MFC with the CNT-textile-Pt cathode was 837 mW m⁻², 2.14 times of that achieved by the MFC with the carbon cloth-Pt cathode (391 mW m⁻²). The MFC prepared with the plain CNT-textile cathode also generated a maximum power density of 177 mW m⁻².

Additionally, after removing this contribution of the CNTs, the CNT-textile-Pt cathode showed 1.7 times better performance than the carbon cloth-Pt cathode, which is indicative of greater catalytic activity of the Pt in CNT-textile-Pt.

The maximum current density achieved by the CNT-textile-Pt cathode was 5.2 A m⁻², which was greater than previously reported values (0.1 A m⁻²).

### Pt Loading

Pt loadings were determined by an IRIS advantage inductively coupled plasma atomic emission spectroscopy (ICP-AES) system. The Pt loading of CNT-textile-Pt was controlled by the charge applied during electrochemical deposition. As shown in Table 2, the Pt loading of the CNT-textile-Pt cathode is five times less than a commercial carbon cloth-Pt cathode (0.048 mg cm⁻² vs. 0.249 mg cm⁻²). Decreasing Pt loading in the CNT-textile-Pt provides a direct approach to reduce the capital cost of the cathode.

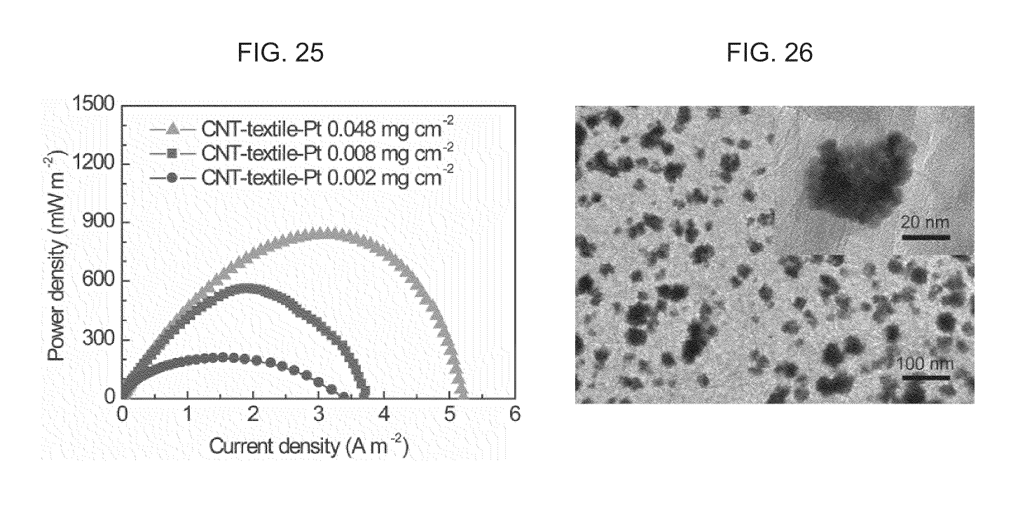

Two more CNT-textile-Pt samples with lower Pt loadings (0.008 mg cm⁻² and 0.002 mg cm⁻²) were synthesized by further decreasing the applied charges to 200 mC and 100 mC, respectively. The maximum power densities of the MFCs equipped with these two cathodes were reduced from 837 mW m² to 559 mW m⁻² and 205 mW m⁻², respectively (FIG. 25). The CNT-textile-Pt with only 3.2% Pt loading compared to that of the commercial carbon cloth-Pt cathode still achieved a 43% higher power density (559 mWm⁻² vs. 391 mWm⁻²).

FIG. 20 (right), shows that the particle sizes of Pt varied from several nanometers to less than 100 nm. However, the bright dots displayed in the scanning micrographs were clusters of several Pt nanoparticles with smaller sizes (FIG. 20, right, inset), an observation confirmed by transmission electron microscopy (TEM) (FIG. 26).

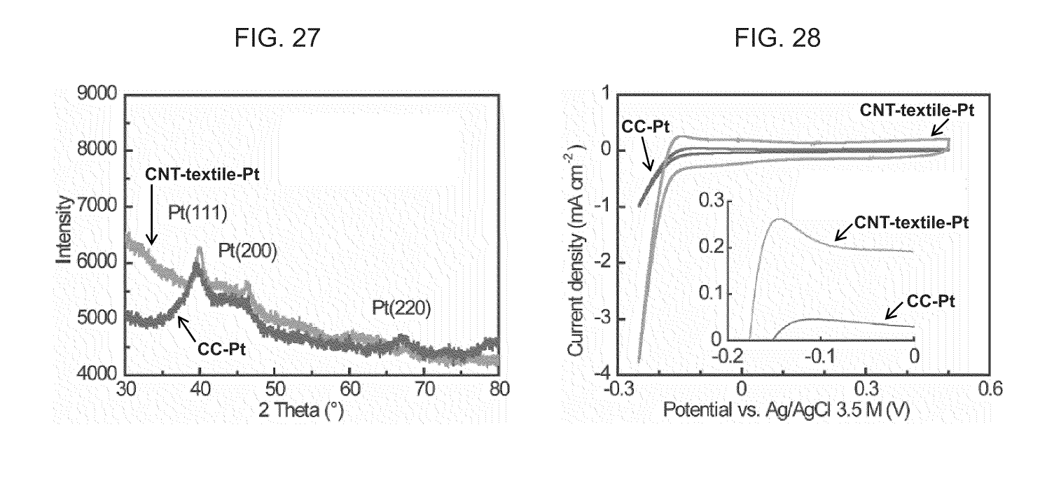

The average sizes of Pt particles on different electrodes were calculated by Debye Scherrer equation, based on the X-ray Diffraction (XRD) test results (FIG. 27), and the results are shown in Table 2.

With the average particle sizes and total Pt loading, the theoretical overall Pt surface area was estimated. As shown in Table 2, the CNT-textile-Pt has less theoretical Pt surface area (14.5 cm² Pt per cm² electrode) than the carbon cloth-Pt (262.5 cm² Pt per cm² electrode) due to the lower mass loading and larger particle sizes. However, the CNT-textile-Pt had larger ECAS area (7.79 cm² Pt per cm² electrode, vs. 0.92 cm² Pt per cm² electrode for CC-Pt), determined by an electrochemical method, in which the ECAS area is proportional to the hydrogen adsorption-desorption capability of the electrode (FIG. 28).

Comparing the surface area utilization efficiency calculated from the ratio of ECAS area to the theoretical surface area, CNT-textile-Pt was two orders better than the carbon cloth-Pt (53.6% vs. 0.4%). Without wishing to be bound by theory, the significant improvement is thought to be due to several reasons: (1) CNT-textile-Pt provided direct electronic pathways for all the Pt particles while CC-Pt has isolated Pt particles where no electronic pathways are formed; (2) CNT-textile-Pt provided macroscale pores for the fast access of electrolyte although CC-Pt has some Pt particles located in small or closed-end pores that are not accessible for the electrolyte; (3) glacial acetic acid treatment in CNT-textile-Pt made the surface hydrophilic for electrolyte wetting while the hydrophobic surface of the CC-Pt hinders the electrode-electrolyte contact.

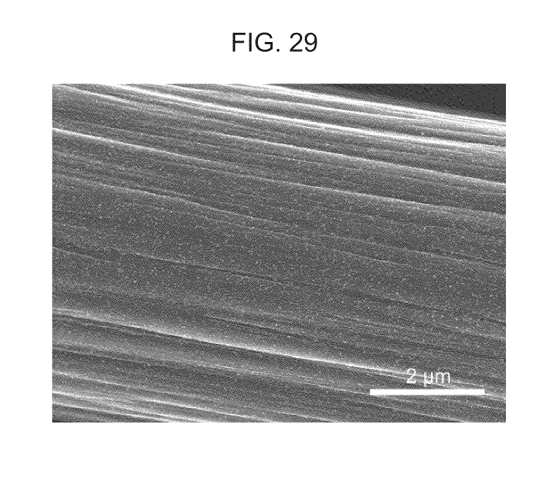

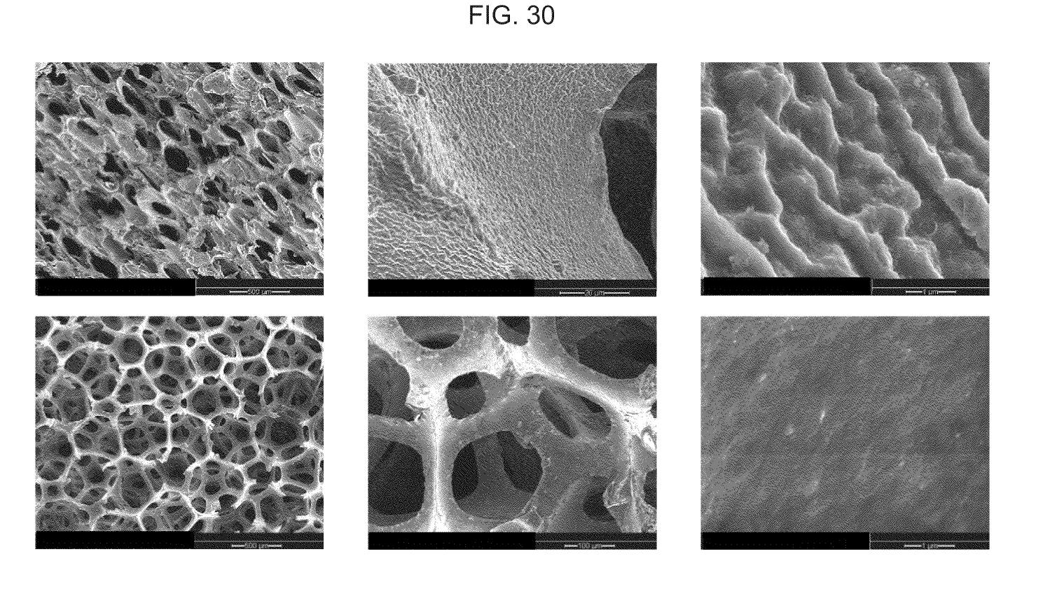

Pt electrochemical deposition was applied on commercial carbon cloth electrodes (Fuel Cell Earth, USA) following the same procedure as described above. The SEM image (FIG. 29) shows that Pt nanoparticles are also uniformly deposited on the carbon fibers. Testing these cathodes in the MFC described above, a maximum power density of 466 mW m⁻² was achieved when the Pt loading is 0.008 mg cm⁻². In contrast, the performance of the CNT-textile-Pt with similar Pt loading was 559 mWm⁻² with a Pt loading of 0.008 mg cm².

TABLE 2
Characterization of CNT-textile-Pt cathode compared with
Carbon Cloth (CC)-Pt cathode

| | CNT-textile-Pt | CC-Pt |
|---|---|---|
| Pt loading/mg cm⁻² | 0.048 | 0.249 |
| Average size of Pt nanoparticles/nm | 9.2 | 2.6 |
| Theoretical surface area^{a}/cm² Pt per cm2 | 14.5 | 262.5 |
| electrode | | |
| Electrochemically active surface area^{b}/cm² | 7.79 | 0.92 |
| Pt per cm² electrode | | |
| Surface area utilization efficiency^{c} (%) | 53.6 | 0.4 |

^{a}Calculated from Pt loading and average particle size.
^{b}Obtained from electrochemical measurement.
^{c}Ratio of electrochemically active surface area to theoretical surface area.

All, document, patents, patent applications, publications, product descriptions, and protocols which are cited throughout this application are incorporated herein by reference in their entireties for all purposes.

The embodiments illustrated and discussed in this specification are intended only to teach those skilled in the art how to make and use certain embodiments of the invention. Modifications and variation of the above-described embodiments of the invention are possible without departing from the invention, as appreciated by those skilled in the art in light of the above teachings. It is therefore understood that, within the scope of the claims and their equivalents, the invention may be practiced otherwise than as specifically described.

1. A microbial fuel cell comprising an anode compartment comprising an anode and a cathode compartment comprising a cathode and a metallic catalyst, wherein the anode and cathode compartments are separated by an ion exchange membrane, at least one of the anode and cathode comprises a porous substrate conformally coated with a conductive nanostructure coating, and the anode and cathode are electrically connected to one another.

2. The microbial fuel cell of claim 1, wherein the mean or median pore cross-section of the pores in the porous substrate is within the range of 100 μm to 100 mm.

3. The microbial fuel cell of claim 2, wherein the mean or median pore cross-section of the pores in the porous substrate is within the range of 1 mm to 10 mm.

4. The microbial fuel cell of claim 2, wherein the mean or median pore cross-section of the pores in the porous substrate is within the range of 100 μm to 1 mm.

5. The microbial fuel cell of claim 1, wherein the porous substrate is selected from one or more of cotton, paper, textile, rubber, wood, synthetic polymer, copper, stainless steel, nickel, ceramic, sponge and glass.

6. The microbial fuel cell of claim 1, wherein the conductive nanostructure coating is a coating of single-wall carbon nanotubes, multi-wall carbon nanotubes, metal nanoparticles, transparent and conductive oxide nanoparticles, metal nanowires, graphene, or a combination thereof.

7. The microbial fuel cell of claim 5, wherein the porous substrate is ceramic, and is selected from at least one of coral, silicon dioxide (SiO₂), silicon nitride (Si₃N₄), aluminum oxide (Al₂O₃), kaolinite (Al₂Si₂O₅(OH)₄), silicon carbide, tungsten carbide and zinc oxide.

8. The microbial fuel cell of claim 1, wherein the anode comprises the porous substrate conformally coated with the conductive nanostructure coating and a biofilm on the nanostructure coating.

9. The microbial fuel cell of claim 8, wherein the biofilm is formed from microbes resident in at least one of wastewater, marine sediment and human excrement.

10. The microbial fuel cell of claim 1, wherein the anode compartment comprises a plurality of anodes.

11. The microbial fuel cell of claim 1, wherein the microbial fuel cell comprises a second microbial fuel cell connected in series or in parallel.

12. The microbial fuel cell of claim 1, wherein the anode compartment includes nutrient media and at least one carbon source.

13. The microbial fuel cell of claim 1, wherein the metallic catalyst comprises at least one of platinum, palladium, gold, ruthenium, rhodium and iridium.

14. The microbial fuel cell of claim 1, wherein the metallic catalyst is in the form of nanoparticles.

15. The microbial fuel cell of claim 1, wherein the cathode comprises the porous substrate conformally coated with the conductive nanostructure coating.

16. The microbial fuel cell of claim 1, comprising a plurality of cathodes or a plurality of anodes.

17. A method for generating an electrical current, comprising:
providing the microbial fuel cell of claim 1, and
introducing a feedstock solution and a nutrient medium to the anode compartment of the microbial fuel cell.

18. The method of claim 17, wherein the nutrient medium comprises glucose.

19. The method of claim 18, further comprising sparging the cathode chamber with air.

20. The method of claim 17, wherein the content of at least one of the cathode and anode chambers is mixed.


SEQUENCE LISTING (2 sequences)

SEQ ID NO: 1 - DNA, 20 bp, Unknown
  Bacterial 16S rRNA PCR primer
agagtttgatcmtggctcag

SEQ ID NO: 2 - DNA, 22 bp, Unknown
  Bacterial 16S rRNA PCR primer
tacggytaccttgttacgactt